(19) United States
(12) Patent Application Publication
(10) Pub. No.: US 2026/0059472 A1
(43) Pub. Date: Feb. 26, 2026

(54) Methods for RTT Based Passive Sidelink Positioning

(71) Applicant: Apple Inc., Cupertino, CA (US)

(72) Inventors: Oghenekome Oteri, San Diego, CA (US); Seyed Ali Akbar Fakoorian, San Diego, CA (US); Ankit Bhamri, Haar (DE); Chunxuan Ye, San Diego, CA (US); Wei Zeng, Saratoga, CA (US); Sigen Ye, San Diego, CA (US); Chunhai Yao, Beijing (CN); Weidong Yang, San Diego, CA (US); Hong He, San Jose, CA (US); Huaning Niu, San Jose, CA (US); Haitong Sun, Saratoga, CA (US)

(21) Appl. No.: 18/998,944

(22) PCT Filed: Aug. 12, 2022
(86) PCT No.: PCT/CN2022/112078

§ 371 Date: Jan. 27, 2025

(51) Int. Cl. H04W 64/00; G01S 11/02; H04W 72/25

(52) U.S. Cl. CPC H04W 64/00; G01S 11/02; H04W 72/25

(57) ABSTRACT

Apparatuses, systems, and methods for RTT based sidelink positioning, e.g., in 5G NR systems and beyond. A UE may receive, from a sidelink LMF, a PRS/SRS configuration and SCI. The UE may receive, from the SL-LMF, a broadcast comprising at least two time stamps associated with transmissions to the UE from one or more neighboring UEs. Further, the UE may determine differential distances to the one or more neighboring UEs. The broadcast from the SL-LMF may include angle of arrival (AoA) information and/or angle of departure (AoD) information and UE may determine an absolute position based on the differential distances and the AoA/AoD information.

### FIELD

The invention relates to wireless communications, and more particularly to apparatuses, systems, and methods for round trip time (RTT) sidelink positioning, e.g., in 5G NR systems and beyond.

### DESCRIPTION OF THE RELATED ART

Wireless communication systems are rapidly growing in usage. In recent years, wireless devices such as smart phones and tablet computers have become increasingly sophisticated. In addition to supporting telephone calls, many mobile devices now provide access to the internet, email, text messaging, and navigation using the global positioning system (GPS) and are capable of operating sophisticated applications that utilize these functionalities.

Long Term Evolution (LTE) is currently the technology of choice for the majority of wireless network operators worldwide, providing mobile broadband data and high-speed Internet access to their subscriber base. LTE was first proposed in 2004 and was first standardized in 2008. Since then, as usage of wireless communication systems has expanded exponentially, demand has risen for wireless network operators to support a higher capacity for a higher density of mobile broadband users. Thus, in 2015 study of a new radio access technology began and, in 2017, a first release of Fifth Generation New Radio (5G NR) was standardized.

5G-NR, also simply referred to as NR, provides, as compared to LTE, a higher capacity for a higher density of mobile broadband users, while also supporting device-to-device, ultra-reliable, and massive machine type communications with lower latency and/or lower battery consumption. Further, NR may allow for more flexible UE scheduling as compared to current LTE. Consequently, efforts are being made in ongoing developments of 5G-NR to take advantage of higher throughputs possible at higher frequencies.

### SUMMARY

Embodiments relate to wireless communications, and more particularly to apparatuses, systems, and methods for RTT based sidelink positioning, e.g., in 5G NR systems and beyond.

For example, in some embodiments, a sidelink location management function (LMF) may be configured to transmit, to at least a first UE, a positioning information request that may be at least one of a Long Term Evolution (LTE) positioning procedure (LPP) positioning information request or an NR positioning protocol A (NRPPa) positioning information request. The sidelink LMF may be configured to allocate resources for an RTT positioning procedure between the first UE and one or more additional UEs. The resources may be allocated for transmission of sidelink positioning reference signals (PRSs) and/or sidelink sounding reference signals (SRSs). Additionally, the sidelink LMF may be configured to transmit, to at least the first UE, a positioning activation request and receive, from at least the first UE, a positioning activation response. Upon completion of the RTT positioning procedure, the sidelink LMF may receive feedback from the first UE and the one or more additional UEs and derive at least a location of the first UE.

As another example, in some embodiments, a UE may be configured to receive, from a sidelink LMF, a positioning information request that may be at least one of a LPP positioning information request or an NRPPa positioning information request. The UE may be configured to receive, from the SL-LMF, an indication of resources allocated for an RTT positioning procedure between the UE and one or more additional UEs. The resources may be allocated for transmission of sidelink PRSs and/or sidelink SRSs. Additionally, the UE may be configured to perform, based on the indication of resources, resource allocation for the RTT positioning procedure with the one or more additional UEs. Further, the UE may be configured to receive, from the SL-LMF, a positioning activation request and transmit a positioning activation response. The UE may then be configured to perform the RTT positioning procedure, which may be any of a single sided RTT/multi-RTT positioning procedure or a double sided RTT/multi-RTT positioning procedure.

As a further example, in some embodiments, a sidelink LMF may be configured to transmit, to a target UE and at least two supporting devices, a PRS/SRS configuration and sidelink control information (SCI). The sidelink LMF may be configured to receive, from the two or more supporting devices, feedback comprising time stamps associated with transmissions from the two or more supporting devices to the target UE. In addition, the sidelink LMF may be configured to broadcast, to at least the target UE, the feedback comprising time stamps associated with transmissions from the two or more supporting devices.

As an additional example, in some embodiments, a UE may be configured to receive, from a sidelink LMF, a PRS/SRS configuration and SCI. The UE may be configured to receive, from the SL-LMF, a broadcast comprising at least two time stamps associated with transmissions to the UE from one or more neighboring UEs. Further, the UE may be configured to determine differential distances to the one or more neighboring UEs. The broadcast from the SL-LMF may include angle of arrival (AoA) information and/or angle of departure (AoD) information and UE may determine an absolute position based on the differential distances and the AoA/AoD information.

The techniques described herein may be implemented in and/or used with a number of different types of devices, including but not limited to unmanned aerial vehicles (UAVs), unmanned aerial controllers (UACs), a UTM server, base stations, access points, cellular phones, tablet computers, wearable computing devices, portable media players, and any of various other computing devices.

This Summary is intended to provide a brief overview of some of the subject matter described in this document. Accordingly, it will be appreciated that the above-described features are merely examples and should not be construed to narrow the scope or spirit of the subject matter described herein in any way. Other features, aspects, and advantages of the subject matter described herein will become apparent from the following Detailed Description, Figures, and Claims.

### BRIEF DESCRIPTION OF THE DRAWINGS

A better understanding of the present subject matter can be obtained when the following detailed description of various embodiments is considered in conjunction with the following drawings, in which:

FIG. 1 illustrates an example wireless communication system according to some embodiments.

FIG. 2 illustrates an example block diagram of a base station, according to some embodiments.

FIG. 3 illustrates an example block diagram of a server, according to some embodiments.

FIG. 4 illustrates an example block diagram of a UE, according to some embodiments.

FIG. 5 illustrates an example of a 5G network architecture that incorporates both dual 3GPP (e.g., LTE and 5G NR) access and non-3GPP access to the 5G CN, according to some embodiments.

FIGS. 6A, 6B, 6C, and 6D illustrate various examples of sidelink RTT signaling for single sided and doubled sided RTT/multi-RTT measurements, according to some embodiments.

FIG. 7 illustrates an example of signaling for a sidelink procedure for RTT, according to some embodiments.

FIG. 8 illustrates an example of signaling for a sidelink procedure for multi-RTT, according to some embodiments.

FIGS. 9A-9D illustrate examples of signaling for a sidelink single sided RTT, according to some embodiments.

FIGS. 10A-10D illustrate examples of signaling for a sidelink double sided RTT, according to some embodiments.

FIG. 11 illustrates a block diagram of an example of a method for round trip time (RTT) based sidelink positioning, according to some embodiments.

FIG. 12 illustrates a block diagram of another example of a method for round trip time (RTT) based sidelink positioning, according to some embodiments.

FIG. 13 illustrates an example of signaling for a passive sidelink ranging procedure with RTT, according to some embodiments.

FIG. 14 illustrates a block diagram of an example of a method for passive sidelink positioning estimation, according to some embodiments.

FIG. 15 illustrates a block diagram of an example of a method for passive sidelink positioning estimation, according to some embodiments.

While the features described herein may be susceptible to various modifications and alternative forms, specific embodiments thereof are shown by way of example in the drawings and are herein described in detail. It should be understood, however, that the drawings and detailed description thereto are not intended to be limiting to the particular form disclosed, but on the contrary, the intention is to cover all modifications, equivalents and alternatives falling within the spirit and scope of the subject matter as defined by the appended claims.

### DETAILED DESCRIPTION

### Acronyms

Various acronyms are used throughout the present disclosure. Definitions of the most prominently used acronyms that may appear throughout the present disclosure are provided below:
3GPP: Third Generation Partnership Project
UE: User Equipment
RF: Radio Frequency
BS: Base Station
DL: Downlink
UL: Uplink
LTE: Long Term Evolution
NR: New Radio
5GS: 5G System
5GMM: 5GS Mobility Management
5GC/5GCN: 5G Core Network
SIM: Subscriber Identity Module
eSIM: Embedded Subscriber Identity Module
IE: Information Element
CE: Control Element
MAC: Medium Access Control
SSB: Synchronization Signal Block
PDCCH: Physical Downlink Control Channel
PDSCH: Physical Downlink Shared Channel
RRC: Radio Resource Control

### Terms

The following is a glossary of terms used in this disclosure:

Memory Medium—Any of various types of non-transitory memory devices or storage devices. The term “memory medium” is intended to include an installation medium, e.g., a CD-ROM, floppy disks, or tape device; a computer system memory or random-access memory such as DRAM, DDR RAM, SRAM, EDO RAM, Rambus RAM, etc.; a non-volatile memory such as a Flash, magnetic media, e.g., a hard drive, or optical storage; registers, or other similar types of memory elements, etc. The memory medium may include other types of non-transitory memory as well or combinations thereof. In addition, the memory medium may be located in a first computer system in which the programs are executed, or may be located in a second different computer system which connects to the first computer system over a network, such as the Internet. In the latter instance, the second computer system may provide program instructions to the first computer for execution. The term “memory medium” may include two or more memory mediums which may reside in different locations, e.g., in different computer systems that are connected over a network. The memory medium may store program instructions (e.g., embodied as computer programs) that may be executed by one or more processors.

Carrier Medium—a memory medium as described above, as well as a physical transmission medium, such as a bus, network, and/or other physical transmission medium that conveys signals such as electrical, electromagnetic, or digital signals.

Programmable Hardware Element—includes various hardware devices comprising multiple programmable function blocks connected via a programmable interconnect. Examples include FPGAs (Field Programmable Gate Arrays), PLDs (Programmable Logic Devices), FPOAs (Field Programmable Object Arrays), and CPLDs (Complex PLDs). The programmable function blocks may range from fine grained (combinatorial logic or look up tables) to coarse grained (arithmetic logic units or processor cores). A programmable hardware element may also be referred to as “reconfigurable logic”.

Computer System (or Computer)—any of various types of computing or processing systems, including a personal computer system (PC), mainframe computer system, workstation, network appliance, Internet appliance, personal digital assistant (PDA), television system, grid computing system, or other device or combinations of devices. In general, the term “computer system” can be broadly defined to encompass any device (or combination of devices) having at least one processor that executes instructions from a memory medium.

User Equipment (UE) (or “UE Device”)—any of various types of computer systems devices which are mobile or portable and which performs wireless communications. Examples of UE devices include mobile telephones or smart phones (e.g., iPhone™, Android™-based phones), portable gaming devices (e.g., Nintendo DS™, PlayStation Portable™, Gameboy Advance™, iPhone™), laptops, wearable devices (e.g., smart watch, smart glasses), PDAS, portable Internet devices, music players, data storage devices, other handheld devices, unmanned aerial vehicles (UAVs) (e.g., drones), UAV controllers (UACs), and so forth. In general, the term “UE” or “UE device” can be broadly defined to encompass any electronic, computing, and/or telecommunications device (or combination of devices) which is easily transported by a user and capable of wireless communication.

Base Station—The term “Base Station” has the full breadth of its ordinary meaning, and at least includes a wireless communication station installed at a fixed location and used to communicate as part of a wireless telephone system or radio system.

Processing Element (or Processor)—refers to various elements or combinations of elements that are capable of performing a function in a device, such as a user equipment or a cellular network device. Processing elements may include, for example: processors and associated memory, portions or circuits of individual processor cores, entire processor cores, processor arrays, circuits such as an ASIC (Application Specific Integrated Circuit), programmable hardware elements such as a field programmable gate array (FPGA), as well any of various combinations of the above.

Channel—a medium used to convey information from a sender (transmitter) to a receiver. It should be noted that since characteristics of the term “channel” may differ according to different wireless protocols, the term “channel” as used herein may be considered as being used in a manner that is consistent with the standard of the type of device with reference to which the term is used. In some standards, channel widths may be variable (e.g., depending on device capability, band conditions, etc.). For example, LTE may support scalable channel bandwidths from 1.4 MHz to 20 MHz. In contrast, WLAN channels may be 22 MHz wide while Bluetooth channels may be 1 Mhz wide. Other protocols and standards may include different definitions of channels. Furthermore, some standards may define and use multiple types of channels, e.g., different channels for uplink or downlink and/or different channels for different uses such as data, control information, etc.

Band—The term “band” has the full breadth of its ordinary meaning, and at least includes a section of spectrum (e.g., radio frequency spectrum) in which channels are used or set aside for the same purpose.

Wi-Fi—The term “Wi-Fi” (or WiFi) has the full breadth of its ordinary meaning, and at least includes a wireless communication network or RAT that is serviced by wireless LAN (WLAN) access points and which provides connectivity through these access points to the Internet. Most modern Wi-Fi networks (or WLAN networks) are based on IEEE 802.11 standards and are marketed under the name “Wi-Fi”. A Wi-Fi (WLAN) network is different from a cellular network.

3GPP Access—refers to accesses (e.g., radio access technologies) that are specified by 3GPP standards. These accesses include, but are not limited to, GSM/GPRS, LTE, LTE-A, and/or 5G NR. In general, 3GPP access refers to various types of cellular access technologies.

Non-3GPP Access—refers any accesses (e.g., radio access technologies) that are not specified by 3GPP standards. These accesses include, but are not limited to, WiMAX, CDMA2000, Wi-Fi, WLAN, and/or fixed networks. Non-3GPP accesses may be split into two categories, “trusted” and “untrusted”: Trusted non-3GPP accesses can interact directly with an evolved packet core (EPC) and/or a 5G core (5GC) whereas untrusted non-3GPP accesses interwork with the EPC/5GC via a network entity, such as an Evolved Packet Data Gateway and/or a 5G NR gateway. In general, non-3GPP access refers to various types on non-cellular access technologies.

Automatically—refers to an action or operation performed by a computer system (e.g., software executed by the computer system) or device (e.g., circuitry, programmable hardware elements, ASICs, etc.), without user input directly specifying or performing the action or operation. Thus, the term “automatically” is in contrast to an operation being manually performed or specified by the user, where the user provides input to directly perform the operation. An automatic procedure may be initiated by input provided by the user, but the subsequent actions that are performed “automatically” are not specified by the user, i.e., are not performed “manually”, where the user specifies each action to perform. For example, a user filling out an electronic form by selecting each field and providing input specifying information (e.g., by typing information, selecting check boxes, radio selections, etc.) is filling out the form manually, even though the computer system must update the form in response to the user actions. The form may be automatically filled out by the computer system where the computer system (e.g., software executing on the computer system) analyzes the fields of the form and fills in the form without any user input specifying the answers to the fields. As indicated above, the user may invoke the automatic filling of the form, but is not involved in the actual filling of the form (e.g., the user is not manually specifying answers to fields but rather they are being automatically completed). The present specification provides various examples of operations being automatically performed in response to actions the user has taken.

Approximately—refers to a value that is almost correct or exact. For example, approximately may refer to a value that is within 1 to 10 percent of the exact (or desired) value. It should be noted, however, that the actual threshold value (or tolerance) may be application dependent. For example, in some embodiments, “approximately” may mean within 0.1% of some specified or desired value, while in various other embodiments, the threshold may be, for example, 2%, 3%, 5%, and so forth, as desired or as required by the particular application.

Concurrent—refers to parallel execution or performance, where tasks, processes, or programs are performed in an at least partially overlapping manner. For example, concurrency may be implemented using “strong” or strict parallelism, where tasks are performed (at least partially) in parallel on respective computational elements, or using “weak parallelism”, where the tasks are performed in an interleaved manner, e.g., by time multiplexing of execution threads.

Various components may be described as “configured to” perform a task or tasks. In such contexts, “configured to” is a broad recitation generally meaning “having structure that” performs the task or tasks during operation. As such, the component can be configured to perform the task even when the component is not currently performing that task (e.g., a set of electrical conductors may be configured to electrically connect a module to another module, even when the two modules are not connected). In some contexts, “configured to” may be a broad recitation of structure generally meaning “having circuitry that” performs the task or tasks during operation. As such, the component can be configured to perform the task even when the component is not currently on. In general, the circuitry that forms the structure corresponding to “configured to” may include hardware circuits.

Various components may be described as performing a task or tasks, for convenience in the description. Such descriptions should be interpreted as including the phrase “configured to.” Reciting a component that is configured to perform one or more tasks is expressly intended not to invoke 35 U.S.C. § 112(f) interpretation for that component.

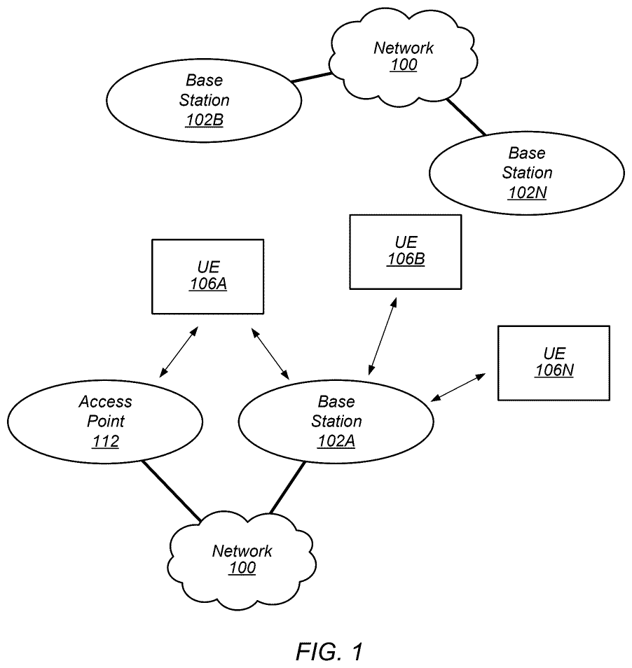

### FIG. 1: Communication System

FIG. 1 illustrates a simplified example wireless communication system, according to some embodiments. It is noted that the system of FIG. 1 is merely one example of a possible system, and that features of this disclosure may be implemented in any of various systems, as desired.

As shown, the example wireless communication system includes a base station 102A which communicates over a transmission medium with one or more user devices 106A, 106B, etc., through 106N. Each of the user devices may be referred to herein as a “user equipment” (UE). Thus, the user devices 106 are referred to as UEs or UE devices.

The base station (BS) 102A may be a base transceiver station (BTS) or cell site (a “cellular base station”) and may include hardware that enables wireless communication with the UEs 106A through 106N.

The communication area (or coverage area) of the base station may be referred to as a “cell.” The base station 102A and the UEs 106 may be configured to communicate over the transmission medium using any of various radio access technologies (RATs), also referred to as wireless communication technologies, or telecommunication standards, such as GSM, UMTS (associated with, for example, WCDMA or TD-SCDMA air interfaces), LTE, LTE-Advanced (LTE-A), 5G new radio (5G NR), HSPA, 3GPP2 CDMA2000 (e.g., 1xRTT, 1xEV-DO, HRPD, eHRPD), etc. Note that if the base station 102A is implemented in the context of LTE, it may alternately be referred to as an ‘eNodeB’ or ‘eNB’. Note that if the base station 102A is implemented in the context of 5G NR, it may alternately be referred to as ‘gNodeB’ or ‘gNB’.

As shown, the base station 102A may also be equipped to communicate with a network 100 (e.g., a core network of a cellular service provider, a telecommunication network such as a public switched telephone network (PSTN), and/or the Internet, among various possibilities). Thus, the base station 102A may facilitate communication between the user devices and/or between the user devices and the network 100. In particular, the cellular base station 102A may provide UEs 106 with various telecommunication capabilities, such as voice, SMS and/or data services.

Base station 102A and other similar base stations (such as base stations 102B . . . 102N) operating according to the same or a different cellular communication standard may thus be provided as a network of cells, which may provide continuous or nearly continuous overlapping service to UEs 106A-N and similar devices over a geographic area via one or more cellular communication standards.

Thus, while base station 102A may act as a “serving cell” for UEs 106A-N as illustrated in FIG. 1, each UE 106 may also be capable of receiving signals from (and possibly within communication range of) one or more other cells (which might be provided by base stations 102B-N and/or any other base stations), which may be referred to as “neighboring cells”. Such cells may also be capable of facilitating communication between user devices and/or between user devices and the network 100. Such cells may include “macro” cells, “micro” cells, “pico” cells, and/or cells which provide any of various other granularities of service area size. For example, base stations 102A-B illustrated in FIG. 1 might be macro cells, while base station 102N might be a micro cell. Other configurations are also possible.

In some embodiments, base station 102A may be a next generation base station, e.g., a 5G New Radio (5G NR) base station, or “gNB”. In some embodiments, a gNB may be connected to a legacy evolved packet core (EPC) network and/or to a NR core (NRC) network. In addition, a gNB cell may include one or more transition and reception points (TRPs). In addition, a UE capable of operating according to 5G NR may be connected to one or more TRPs within one or more gNBs.

In addition, the UE 106 may be in communication with an access point 112, e.g., using a wireless networking (e.g., Wi-Fi) and/or peer-to-peer wireless communication protocol (e.g., Bluetooth, Wi-Fi peer-to-peer, etc.). The access point 112 may provide a connection to the network 100.

Note that a UE 106 may be capable of communicating using multiple wireless communication standards. For example, the UE 106 may be configured to communicate using a wireless networking (e.g., Wi-Fi) and/or peer-to-peer wireless communication protocol (e.g., Bluetooth, Wi-Fi peer-to-peer, etc.) in addition to at least one cellular communication protocol (e.g., GSM, UMTS (associated with, for example, WCDMA or TD-SCDMA air interfaces), LTE, LTE-A, 5G NR, HSPA, 3GPP2 CDMA2000 (e.g., 1xRTT, 1xEV-DO, HRPD, eHRPD), etc.). The UE 106 may also or alternatively be configured to communicate using one or more global navigational satellite systems (GNSS, e.g., GPS or GLONASS), one or more mobile television broadcasting standards (e.g., ATSC-M/H or DVB-H), and/or any other wireless communication protocol, if desired. Other combinations of wireless communication standards (including more than two wireless communication standards) are also possible.

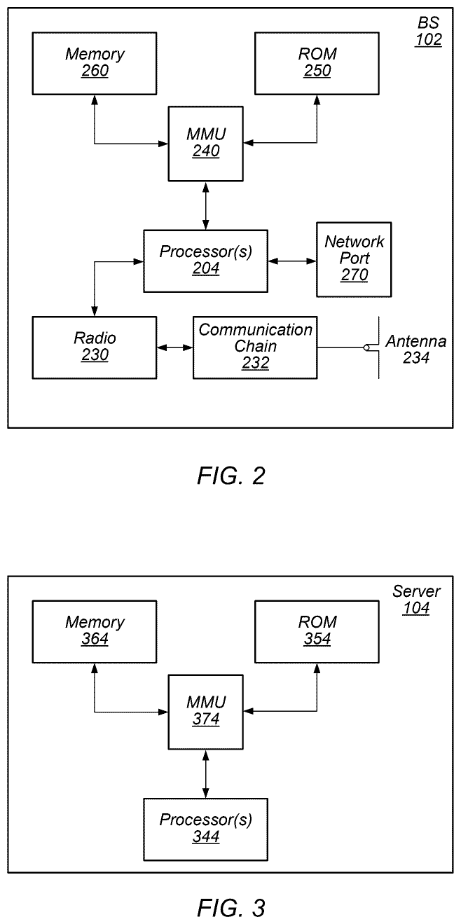

### FIG. 2: Block Diagram of a Base Station

FIG. 2 illustrates an example block diagram of a base station 102, according to some embodiments. It is noted that the base station of FIG. 3 is merely one example of a possible base station. As shown, the base station 102 may include processor(s) 204 which may execute program instructions for the base station 102. The processor(s) 204 may also be coupled to memory management unit (MMU) 240, which may be configured to receive addresses from the processor(s) 204 and translate those addresses to locations in memory (e.g., memory 260 and read only memory (ROM) 250) or to other circuits or devices.

The base station 102 may include at least one network port 270. The network port 270 may be configured to couple to a telephone network and provide a plurality of devices, such as UE devices 106, access to the telephone network as described above in FIGS. 1 and 2.

The network port 270 (or an additional network port) may also or alternatively be configured to couple to a cellular network, e.g., a core network of a cellular service provider. The core network may provide mobility related services and/or other services to a plurality of devices, such as UE devices 106. In some cases, the network port 270 may couple to a telephone network via the core network, and/or the core network may provide a telephone network (e.g., among other UE devices serviced by the cellular service provider).

In some embodiments, base station 102 may be a next generation base station, e.g., a 5G New Radio (5G NR) base station, or “gNB”. In such embodiments, base station 102 may be connected to a legacy evolved packet core (EPC) network and/or to a NR core (NRC) network. In addition, base station 102 may be considered a 5G NR cell and may include one or more transition and reception points (TRPs). In addition, a UE capable of operating according to 5G NR may be connected to one or more TRPs within one or more gNBs.

The base station 102 may include at least one antenna 234, and possibly multiple antennas. The at least one antenna 234 may be configured to operate as a wireless transceiver and may be further configured to communicate with UE devices 106 via radio 230. The antenna 234 communicates with the radio 230 via communication chain 232. Communication chain 232 may be a receive chain, a transmit chain or both. The radio 230 may be configured to communicate via various wireless communication standards, including, but not limited to, 5G NR, LTE, LTE-A, GSM, UMTS, CDMA2000, Wi-Fi, etc.

The base station 102 may be configured to communicate wirelessly using multiple wireless communication standards. In some instances, the base station 102 may include multiple radios, which may enable the base station 102 to communicate according to multiple wireless communication technologies. For example, as one possibility, the base station 102 may include an LTE radio for performing communication according to LTE as well as a 5G NR radio for performing communication according to 5G NR. In such a case, the base station 102 may be capable of operating as both an LTE base station and a 5G NR base station. As another possibility, the base station 102 may include a multi-mode radio which is capable of performing communications according to any of multiple wireless communication technologies (e.g., 5G NR and Wi-Fi, LTE and Wi-Fi, LTE and UMTS, LTE and CDMA2000, UMTS and GSM, etc.).

As described further subsequently herein, the BS 102 may include hardware and software components for implementing or supporting implementation of features described herein. The processor 204 of the base station 102 may be configured to implement or support implementation of part or all of the methods described herein, e.g., by executing program instructions stored on a memory medium (e.g., a non-transitory computer-readable memory medium). Alternatively, the processor 204 may be configured as a programmable hardware element, such as an FPGA (Field Programmable Gate Array), or as an ASIC (Application Specific Integrated Circuit), or a combination thereof. Alternatively (or in addition) the processor 204 of the BS 102, in conjunction with one or more of the other components 230, 232, 234, 240, 250, 260, 270 may be configured to implement or support implementation of part or all of the features described herein.

In addition, as described herein, processor(s) 204 may be comprised of one or more processing elements. In other words, one or more processing elements may be included in processor(s) 204. Thus, processor(s) 204 may include one or more integrated circuits (ICs) that are configured to perform the functions of processor(s) 204. In addition, each integrated circuit may include circuitry (e.g., first circuitry, second circuitry, etc.) configured to perform the functions of processor(s) 204.

Further, as described herein, radio 230 may be comprised of one or more processing elements. In other words, one or more processing elements may be included in radio 230. Thus, radio 230 may include one or more integrated circuits (ICs) that are configured to perform the functions of radio 230. In addition, each integrated circuit may include circuitry (e.g., first circuitry, second circuitry, etc.) configured to perform the functions of radio 230.

### FIG. 3: Block Diagram of a Server

FIG. 3 illustrates an example block diagram of a server 104, according to some embodiments. It is noted that the server of FIG. 3 is merely one example of a possible server. As shown, the server 104 may include processor(s) 344 which may execute program instructions for the server 104. The processor(s) 344 may also be coupled to memory management unit (MMU) 374, which may be configured to receive addresses from the processor(s) 344 and translate those addresses to locations in memory (e.g., memory 364 and read only memory (ROM) 354) or to other circuits or devices.

The server 104 may be configured to provide a plurality of devices, such as base station 102, UE devices 106, and/or UTM 108, access to network functions, e.g., as further described herein.

In some embodiments, the server 104 may be part of a radio access network, such as a 5G New Radio (5G NR) radio access network. In some embodiments, the server 104 may be connected to a legacy evolved packet core (EPC) network and/or to a NR core (NRC) network.

As described further subsequently herein, the server 104 may include hardware and software components for implementing or supporting implementation of features described herein. The processor 344 of the server 104 may be configured to implement or support implementation of part or all of the methods described herein, e.g., by executing program instructions stored on a memory medium (e.g., a non-transitory computer-readable memory medium). Alternatively, the processor 344 may be configured as a programmable hardware element, such as an FPGA (Field Programmable Gate Array), or as an ASIC (Application Specific Integrated Circuit), or a combination thereof. Alternatively (or in addition) the processor 344 of the server 104, in conjunction with one or more of the other components 354, 364, and/or 374 may be configured to implement or support implementation of part or all of the features described herein.

In addition, as described herein, processor(s) 344 may be comprised of one or more processing elements. In other words, one or more processing elements may be included in processor(s) 344. Thus, processor(s) 344 may include one or more integrated circuits (ICs) that are configured to perform the functions of processor(s) 344. In addition, each integrated circuit may include circuitry (e.g., first circuitry, second circuitry, etc.) configured to perform the functions of processor(s) 344.

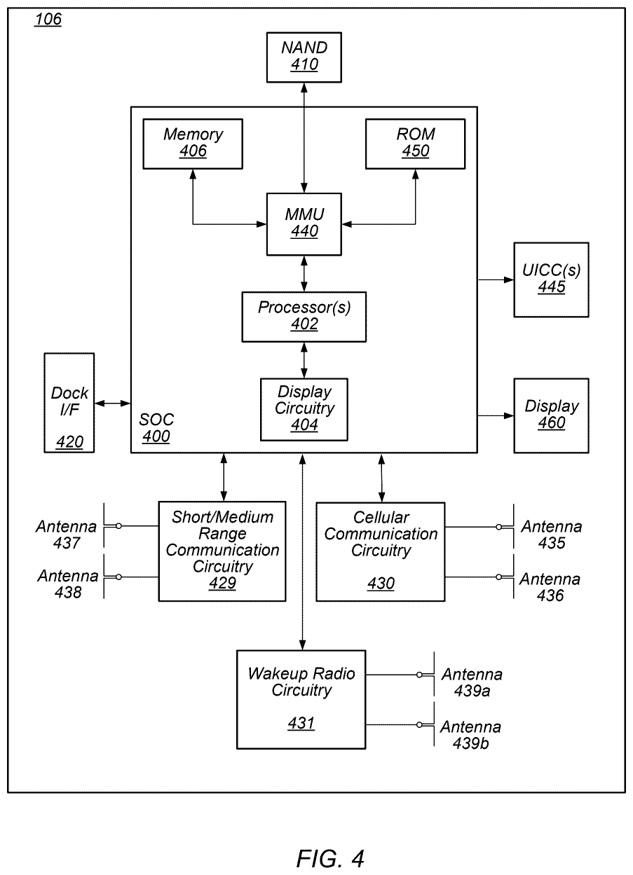

### FIG. 4: Block Diagram of a UE

FIG. 4 illustrates an example simplified block diagram of a communication device 106, according to some embodiments. It is noted that the block diagram of the communication device of FIG. 4 is only one example of a possible communication device. According to embodiments, communication device 106 may be a user equipment (UE) device, a mobile device or mobile station, a wireless device or wireless station, a desktop computer or computing device, a mobile computing device (e.g., a laptop, notebook, or portable computing device), a tablet, an unmanned aerial vehicle (UAV), a UAV controller (UAC) and/or a combination of devices, among other devices. As shown, the communication device 106 may include a set of components 400 configured to perform core functions. For example, this set of components may be implemented as a system on chip (SOC), which may include portions for various purposes. Alternatively, this set of components 400 may be implemented as separate components or groups of components for the various purposes. The set of components 400 may be coupled (e.g., communicatively; directly or indirectly) to various other circuits of the communication device 106.

For example, the communication device 106 may include various types of memory (e.g., including NAND flash 410), an input/output interface such as connector I/F 420 (e.g., for connecting to a computer system; dock; charging station; input devices, such as a microphone, camera, keyboard; output devices, such as speakers; etc.), the display 460, which may be integrated with or external to the communication device 106, and cellular communication circuitry 430 such as for 5G NR, LTE, GSM, etc., short to medium range wireless communication circuitry 429 (e.g., Bluetooth™ and WLAN circuitry), and wakeup radio circuitry 431. In some embodiments, communication device 106 may include wired communication circuitry (not shown), such as a network interface card, e.g., for Ethernet.

The cellular communication circuitry 430 may couple (e.g., communicatively; directly or indirectly) to one or more antennas, such as antennas 435 and 436 as shown. The short to medium range wireless communication circuitry 429 may also couple (e.g., communicatively; directly or indirectly) to one or more antennas, such as antennas 437 and 438 as shown. Alternatively, the short to medium range wireless communication circuitry 429 may couple (e.g., communicatively; directly or indirectly) to the antennas 435 and 436 in addition to, or instead of, coupling (e.g., communicatively; directly or indirectly) to the antennas 437 and 438. The wakeup radio circuitry 431 may also couple (e.g., communicatively; directly or indirectly) to one or more antennas, such as antennas 439a and 439b as shown. Alternatively, the wakeup radio circuitry 431 may couple (e.g., communicatively; directly or indirectly) to the antennas 435 and 436 in addition to, or instead of, coupling (e.g., communicatively; directly or indirectly) to the antennas 439a and 439b. The short to medium range wireless communication circuitry 429 and/or cellular communication circuitry 430 may include multiple receive chains and/or multiple transmit chains for receiving and/or transmitting multiple spatial streams, such as in a multiple-input multiple output (MIMO) configuration. The wakeup radio circuitry 431 may include a wakeup receiver, e.g., wakeup radio circuitry 431 may be a wakeup receiver. In some instances, wakeup radio circuitry 431 may be a low power and/or ultra-low power wakeup receiver. In some instances, wakeup radio circuitry may only be powered/active when cellular communication circuitry 430 and/or the short to medium range wireless communication circuitry 429 are in a sleep/no power/inactive state. In some instances, wakeup radio circuitry 431 may monitor (e.g., periodically) a specific frequency/channel for a wakeup signal. Receipt of the wakeup signal may trigger the wakeup radio circuitry 431 to notify (e.g., directly and/or indirectly) cellular communication circuitry 430 to enter a powered/active state.

In some embodiments, as further described below, cellular communication circuitry 430 may include dedicated receive chains (including and/or coupled to, e.g., communicatively; directly or indirectly. dedicated processors and/or radios) for multiple RATs (e.g., a first receive chain for LTE and a second receive chain for 5G NR). In addition, in some embodiments, cellular communication circuitry 430 may include a single transmit chain that may be switched between radios dedicated to specific RATs. For example, a first radio may be dedicated to a first RAT, e.g., LTE, and may be in communication with a dedicated receive chain and a transmit chain shared with an additional radio, e.g., a second radio that may be dedicated to a second RAT, e.g., 5G NR, and may be in communication with a dedicated receive chain and the shared transmit chain.

The communication device 106 may also include and/or be configured for use with one or more user interface elements. The user interface elements may include any of various elements, such as display 460 (which may be a touchscreen display), a keyboard (which may be a discrete keyboard or may be implemented as part of a touchscreen display), a mouse, a microphone and/or speakers, one or more cameras, one or more buttons, and/or any of various other elements capable of providing information to a user and/or receiving or interpreting user input.

The communication device 106 may further include one or more smart cards 445 that include SIM (Subscriber Identity Module) functionality, such as one or more UICC(s) (Universal Integrated Circuit Card(s)) cards 445. Note that the term “SIM” or “SIM entity” is intended to include any of various types of SIM implementations or SIM functionality, such as the one or more UICC(s) cards 445, one or more eUICCs, one or more eSIMs, either removable or embedded, etc. In some embodiments, the UE 106 may include at least two SIMs. Each SIM may execute one or more SIM applications and/or otherwise implement SIM functionality. Thus, each SIM may be a single smart card that may be embedded, e.g., may be soldered onto a circuit board in the UE 106, or each SIM 410 may be implemented as a removable smart card. Thus, the SIM(s) may be one or more removable smart cards (such as UICC cards, which are sometimes referred to as “SIM cards”), and/or the SIMS 410 may be one or more embedded cards (such as embedded UICCs (eUICCs), which are sometimes referred to as “eSIMs” or “eSIM cards”).

As shown, the SOC 400 may include processor(s) 402, which may execute program instructions for the communication device 106 and display circuitry 404, which may perform graphics processing and provide display signals to the display 460. The processor(s) 402 may also be coupled to memory management unit (MMU) 440, which may be configured to receive addresses from the processor(s) 402 and translate those addresses to locations in memory (e.g., memory 406, read only memory (ROM) 450, NAND flash memory 410) and/or to other circuits or devices, such as the display circuitry 404, short to medium range wireless communication circuitry 429, cellular communication circuitry 430, connector I/F 420, and/or display 460. The MMU 440 may be configured to perform memory protection and page table translation or set up. In some embodiments, the MMU 440 may be included as a portion of the processor(s) 402.

As noted above, the communication device 106 may be configured to communicate using wireless and/or wired communication circuitry. The communication device 106 may be configured to perform methods for revocation and/or modification of user consent in MEC, e.g., in 5G NR systems and beyond, as further described herein. For example, the communication device 106 may be configured to perform methods for CORESET #0 configuration, SSB/CORESET #0 multiplexing pattern 1 for mixed SCS, time-domain ROs determination for 480 kHz/960 kHz SCSs, and RA-RNTI determination for 480 kHz/960 kHz SCSs.

As described herein, the communication device 106 may include hardware and software components for implementing the above features for a communication device 106 to communicate a scheduling profile for power savings to a network. The processor 402 of the communication device 106 may be configured to implement part or all of the features described herein, e.g., by executing program instructions stored on a memory medium (e.g., a non-transitory computer-readable memory medium). Alternatively (or in addition), processor 402 may be configured as a programmable hardware element, such as an FPGA (Field Programmable Gate Array), or as an ASIC (Application Specific Integrated Circuit). Alternatively (or in addition) the processor 402 of the communication device 106, in conjunction with one or more of the other components 400, 404, 406, 410, 420, 429, 430, 440, 445, 450, 460 may be configured to implement part or all of the features described herein.

In addition, as described herein, processor 402 may include one or more processing elements. Thus, processor 402 may include one or more integrated circuits (ICs) that are configured to perform the functions of processor 402. In addition, each integrated circuit may include circuitry (e.g., first circuitry, second circuitry, etc.) configured to perform the functions of processor(s) 402.

Further, as described herein, cellular communication circuitry 430 and short to medium range wireless communication circuitry 429 may each include one or more processing elements. In other words, one or more processing elements may be included in cellular communication circuitry 430 and, similarly, one or more processing elements may be included in short to medium range wireless communication circuitry 429. Thus, cellular communication circuitry 430 may include one or more integrated circuits (ICs) that are configured to perform the functions of cellular communication circuitry 430. In addition, each integrated circuit may include circuitry (e.g., first circuitry, second circuitry, etc.) configured to perform the functions of cellular communication circuitry 430. Similarly, the short to medium range wireless communication circuitry 429 may include one or more ICs that are configured to perform the functions of short to medium range wireless communication circuitry 429. In addition, each integrated circuit may include circuitry (e.g., first circuitry, second circuitry, etc.) configured to perform the functions of short to medium range wireless communication circuitry 429.

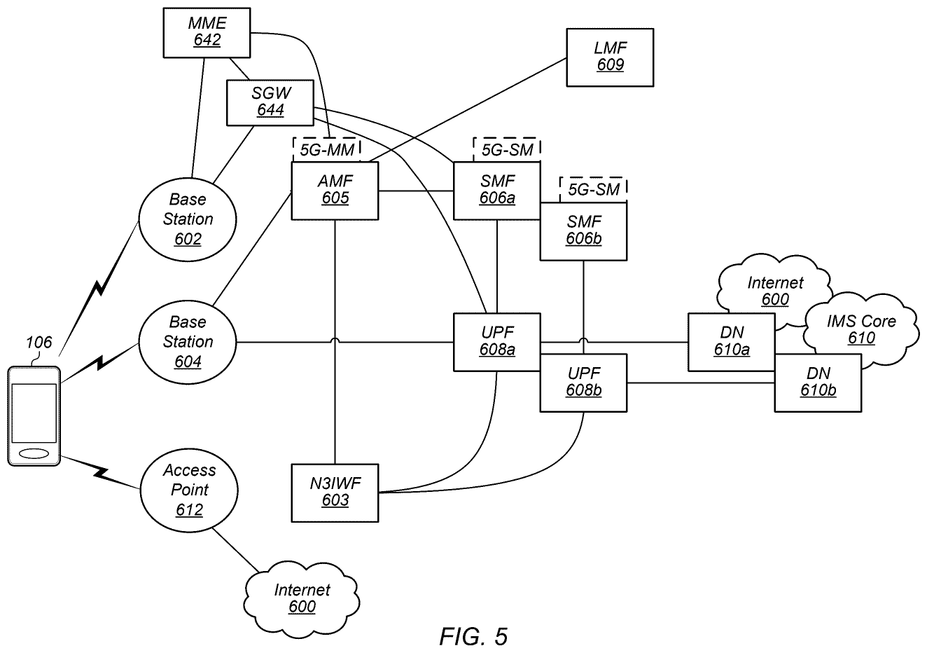

### FIG. 5: 5G Core Network Architecture—Interworking With Wi-Fi

In some embodiments, the 5G core network (CN) may be accessed via (or through) a cellular connection/interface (e.g., via a 3GPP communication architecture/protocol) and a non-cellular connection/interface (e.g., a non-3GPP access architecture/protocol such as Wi-Fi connection). FIG. 5 illustrates an example of a 5G network architecture that incorporates both dual 3GPP (e.g., cellular access via LTE and 5G-NR) and non-3GPP (e.g., non-cellular) access to the 5G CN, according to some embodiments. As shown, a user equipment device (e.g., such as UE 106) may access the 5G CN through both a radio access network (RAN, e.g., such as gNB 604 or eNB 602, each of which may be a base station 102) and an access point, such as AP 612. The AP 612 may include a connection to the Internet 600 as well as a connection to a non-3GPP inter-working function (N3IWF) 603 network entity. The N3IWF may include a connection to a core access and mobility management function (AMF) 605 of the 5G CN. The AMF 605 may include an instance of a 5G mobility management (5G MM) function associated with the UE 106. In addition, the RAN (e.g., gNB 604) may also have a connection to the AMF 605. Thus, the 5G CN may support unified authentication over both connections as well as allow simultaneous registration for UE 106 access via both gNB 604 and AP 612. As shown, the AMF 605 may be in communication with a location management function (LMF) 609 via a networking interface, such as an NLs interface. The LMF 609 may receive measurements and assistance information from the RAN (e.g., gNB 604) and the UE (e.g., UE 106) via the AMF 605. The LMF 609 may be a server (e.g., server 104) and/or a functional entity executing on a server. Further, based on the measurements and/or assistance information received from the RAN and the UE, the LMF may determine a location of the UE. In addition, the AMF 605 may include functional entities associated with the 5G CN (e.g., such as a network slice selection function (NSSF), a short message service function 622, an application function (AF), unified data management (UDM), a policy control function (PCF), and/or an authentication server function. Note that these functional entities may also be supported by a session management function (SMF) 606a and an SMF 606b of the 5G CN. The AMF 605 may be connected to (or in communication with) the SMF 606a. Further, the gNB 604 may in communication with (or connected to) a user plane function (UPF) 608a that may also be communication with the SMF 606a. Similarly, the N3IWF 603 may be communicating with a UPF 608b that may also be communicating with the SMF 606b. Both UPFs may be communicating with the data network (e.g., DN 610a and 610b) and/or the Internet 600 and Internet Protocol (IP) Multimedia Subsystem/IP Multimedia Core Network Subsystem (IMS) core network 610.

Note that in various embodiments, one or more of the above-described entities may be configured to perform methods for RTT based sidelink positioning, e.g., in 5G NR systems and beyond, e.g., as further described herein.

### RTT Based Sidelink Positioning

In current implementations, methods for sidelink positioning in cellular systems, e.g., such as NR cellular systems have not been defined and/or agreed upon. However, it has been agreed upon to study sidelink positioning measurement methods based on RTT-type solutions, angle of arrival (AoA) based solutions (including both Azimuth of arrival and Zenith of arrival), time-different of arrival (TDOA) based solutions, and angle of departure (AoD) based solutions (including both Azimuth of departure and Zenith of departure). Further, it has been agreed upon that studies should include aspects such as definition(s) of corresponding sidelink measurements for each method, which methods may be applicable to absolute or relative positioning or ranging, antenna configuration consideration(s) using practical UE capabilities, per-panel location, e.g., if a UE uses multiple panels, a UE's mobility, especially for V2X scenarios, impact of synchronization error(s) between UEs, and whether existing sidelink measurements (e.g. such as reference signal receive power (RSRP) and/or received signal strength indicator (RSSI)) and UE identity (ID) information may be used.

In some implementations, round trip time (RTT) based positioning may remove a requirement of tight network timing synchronization across nodes (e.g., as needed in legacy techniques such as TDOA) and may offer additional flexibility in network deployment and maintenance. In addition, multi-RTT positioning method may make use of a UE's receive-transmit (Rx−Tx) time difference measurements and downlink positioning reference signal (PRS) RSRP (PRS-RSRP) of downlink signals received from multiple transmit-receive points (TRPs) measured by the UE and measured base station gNB Rx−Tx time difference measurements and uplink sounding reference signal (SRS) RSRP (SRS-RSRP) at multiple TRPs of uplink signals transmitted from UE to derive a location/position of the UE. For example, in current 5G NR systems, for multi-RTT, a location management function (LMF) of the network may initiate a procedure whereby multiple TRPs and a UE perform the base station Rx−TX and UE Rx−Tx measurements, respectively. For multi-RTT, the base stations may transmit downlink PRSs and the UE may transmit uplink SRSs. The base station configures the uplink SRS to the UE using a radio resource control (RRC) protocol and the LMF provides the downlink PRS configuration using an LTE positioning protocol (LPP). The UE then reports measurement results using LPP to the LMF and the base stations report measurement results using NR positioning protocol A (NRPPa) to the LMF. The LMF then estimates the location of the UE.

Embodiments described herein provide systems, methods, and mechanisms for RTT based sidelink positioning, including systems, methods, mechanisms for sidelink RTT and/or multi-RTT for absolute and relative positioning (e.g., for both single sided and double sided RTT). In addition, embodiments described herein provide systems, methods, and mechanisms for passive sideling ranging with RTT. Thus, embodiments described herein address identified problems in the field such as how to define sidelink RTT and sidelink multi-RTT for absolute and relative positioning, what is a procedure for enabling sidelink positioning using absolute and/or relative positioning and how the procedure may be implements for either single sided and/or double sided RTT, including identification of additional design options for both single sided and double sided multi-RTT, which device may request a positioning procedure and which device may originate a reference signal transmissions for measurement. In addition, embodiments described herein address how to implement positioning for low power and/or high privacy UEs.

For example, in some instances, for single sided and/or double sided multi-RTT for absolute positioning derivation, a UE position and/or location may be estimated based on measurements performed at multiple sidelink devices (e.g., such as other UEs, roadside units (RSUs), and/or positioning reference units (PRUs)) (e.g., in a sidelink multi-RTT scheme) and/or a mix of sidelink devices and network entities and/or devices (e.g., such as base stations and/or multiple transmit-receive points (TRPs)) (e.g., in a hybrid sidelink multi-RTT scheme). In some instances, the measurements performed may be UE-sidelink device receive-transmit (Rx−Tx) time difference measurements and/or UE-network entity Rx−Tx time difference measurements of sidelink positioning reference signals (PRSs), downlink PRSs, and/or uplink sounding reference signals (SRSs). In some instances, the measurements performed may be reference signal received power (RSRP) of sidelink PRSs, downlink PRSs, and/or uplink SRSs. Note that to acquire at least three RTT measurements between the UE (e.g., target UE) and supporting devices (e.g., other sidelink devices and/or network entities), an RTT estimate is required between the UE the supporting devices. The distances obtained from the multi-RTT procedure may then be used to trilaterate an absolute position of the UE. In some instances, such a scheme may require the UE and up to three supporting devices. Note that in some instances, for a hybrid sidelink positioning scheme (e.g., where at least one supporting device is a network entity) and/or for a positioning estimation for a UE in partial network coverage, a location management function (LMF) of the network may be used to determine a position of the UE and/or may be used to derive/calculate RTTs. Note further, that in some instances, for a standalone sidelink positioning scheme (e.g., where none of the supporting devices are network entities) and/or for an out-of-coverage sidelink positioning scheme (e.g., the UE does not have network service/coverage), a designated UE may function as a sidelink LMF (SL-LMF) and may be used to determine a position of the UE and/or may be used to derive/calculate RTTs. In some instances, for single sided RTT, a PRS transmission may be considered a pair of transmissions between devices, e.g., a first transmission from a first device to a second device and a second transmission from the second device to the first device. Further, in some instances, for double sided RTT, the PRS transmissions are such that there are three transmissions with a first transmission from first device to the second device, a second transmission from the second device to the first device, and a third transmission from the first device to the second device. Note that the UE (e.g., the target UE) may be either the first device or the second device. The, a device requesting a sidelink positioning procedure may be a target UE, an LMF, a SL-LM, and/or a supporting UE. In some instances, a UE may require measurement gaps to perform the multi-RTT measurements from network entities and/or from sidelink devices (e.g., at least for in coverage UEs). In some instances, e.g., such as measurements involving NR TRPs, the UE may request measurement gaps from a base station.

As another example, for single sided and/or double sided RTT for relative and/or absolute positioning derivation, a UE position and/or location may be estimated based on measurements performed between the UE (e.g., target UE) and a supporting device (e.g., such as an other UE, an RSU, and/or a PRU in a sidelink RTT scheme and/or a network entity (e.g., base station and/or TRP) in a hybrid sidelink RTT scheme). In some instances, the measurements performed may be UE-sidelink device Rx−Tx time difference measurements and/or UE-network entity Rx−Tx time difference measurements of sidelink PRSs, downlink PRSs, and/or uplink SRSs. In some instances, the measurements performed may be reference signal received power (RSRP) of sidelink PRSs, downlink PRSs, and/or uplink SRSs. The distance obtained from the RTT procedure may then be used to estimate a relative position of the UE. In some instances, an additionally estimated angle of arrival (AoA) and/or angle of departure (AoD) may be used to estimate an absolute position of the UE. In some instances, such a scheme may require the UE and one supporting device. Note that in some instances, for a hybrid sidelink positioning scheme (e.g., where at least one supporting device is a network entity) and/or for a positioning estimation for a UE in partial network coverage, a location management function (LMF) of the network may be used to determine a position of the UE and/or may be used to derive/calculate RTTs. Note further, that in some instances, for a standalone sidelink positioning scheme (e.g., where none of the supporting devices are network entities) and/or for an out-of-coverage sidelink positioning scheme (e.g., the UE does not have network service/coverage), a designated UE may function as a sidelink LMF (SL-LMF) and may be used to determine a position of the UE and/or may be used to derive/calculate RTTs. In some instances, for single sided RTT, a PRS transmission may be considered a pair of transmissions between devices, e.g., a first transmission from a first device to a second device and a second transmission from the second device to the first device. Further, in some instances, for double sided RTT, the PRS transmissions are such that there are three transmissions with a first transmission from first device to the second device, a second transmission from the second device to the first device, and a third transmission from the first device to the second device. Note that the UE (e.g., the target UE) may be either the first device or the second device. The, a device requesting a sidelink positioning procedure may be a target UE, an LMF, a SL-LM, and/or a supporting UE.

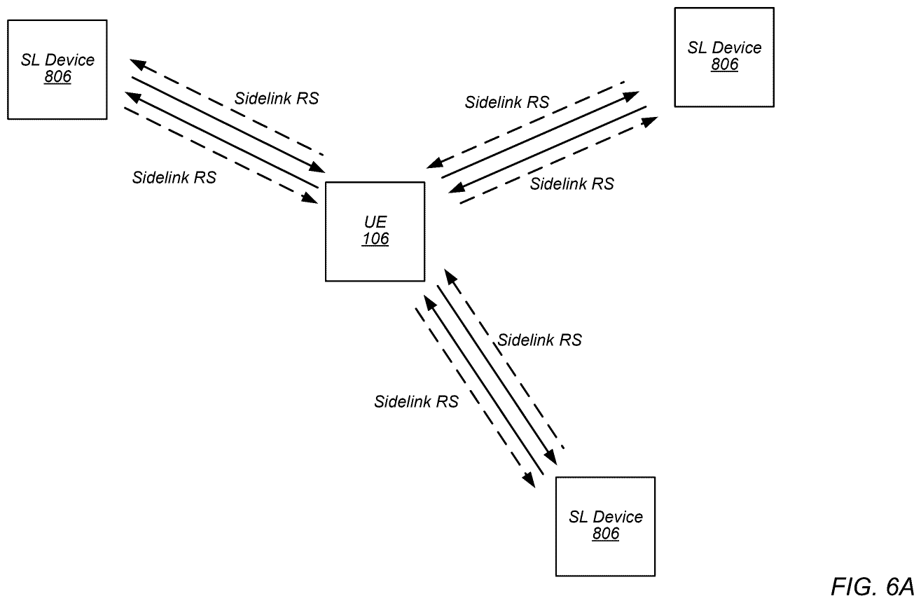

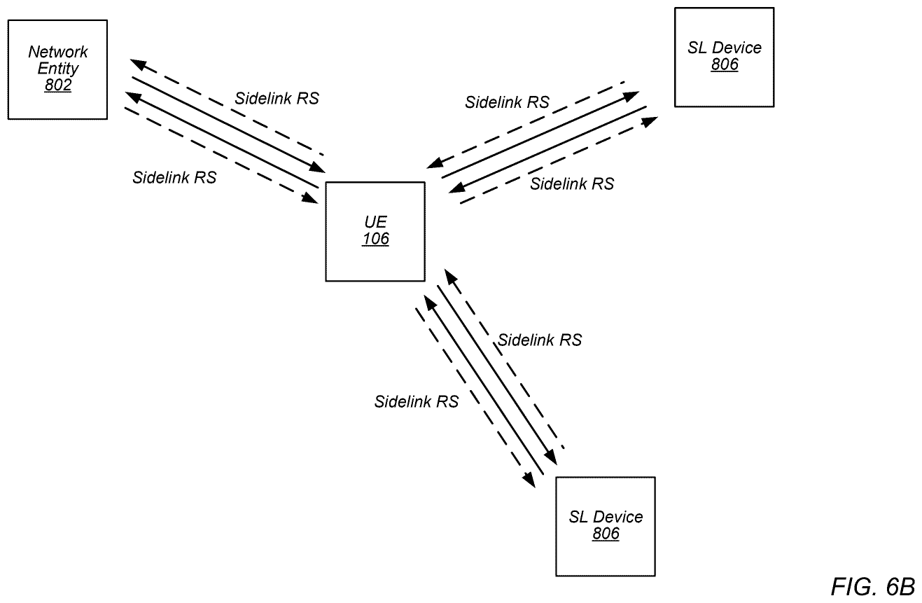

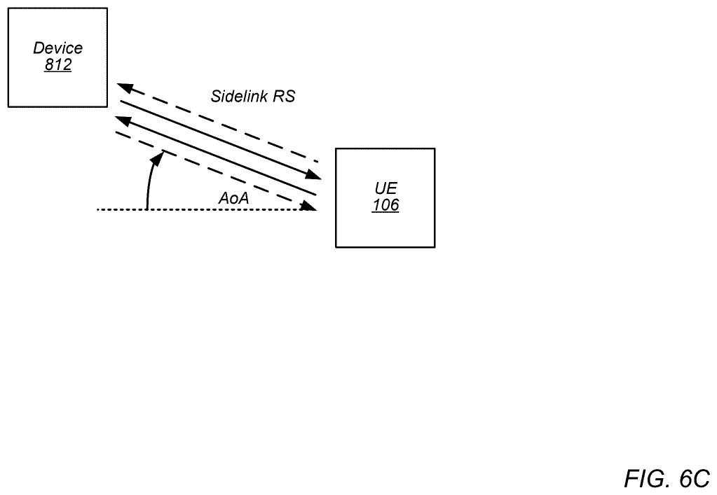

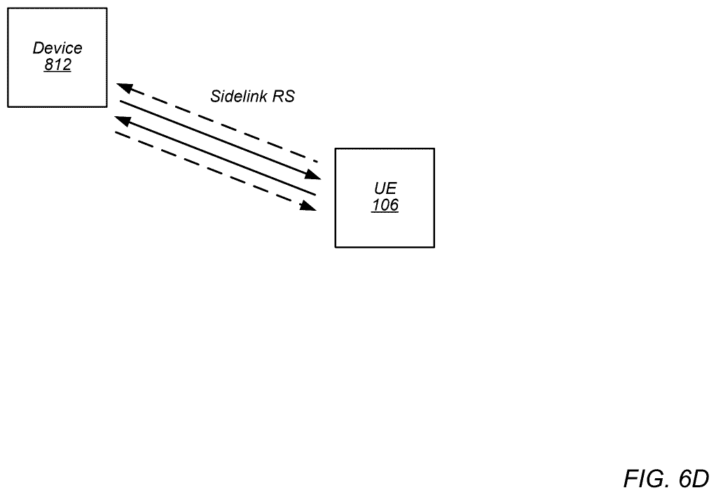

FIGS. 6A, 6B, 6C, and 6D illustrate various examples of sidelink RTT signaling for single sided and doubled sided RTT/multi-RTT measurements, according to some embodiments. For example, FIG. 6A illustrates a multi-RTT scheme in which an absolute position of a UE may be determined using supporting sidelink devices. As shown, a UE 106, which may be a target UE, may exchange sidelink reference signals (RSS) (e.g., such as sidelink PRSs and/or sidelink SRSs) with supporting sidelink devices 806 (e.g., such as other UEs, RSUs and/or PSUs). As another example, FIG. 6B illustrates a hybrid multi-RTT scheme in which an absolute position of a UE may be determined using supporting sidelink devices and/or supporting network entities. As shown, a UE 106, which may be a target UE, may exchange sidelink reference signals (RSs) (e.g., such as sidelink PRSs and/or sidelink SRSs) with supporting sidelink devices 806 (e.g., such as other UEs, RSUs and/or PSUs) as well as a network entity 802 (e.g., which may be a TRP and/or base station, such as base station 102). As a further example, FIG. 6C illustrates an enhanced RTT scheme in which an absolute position of a UE may be determined using a supporting device (e.g., such as an other UE, a RSU, a PSU, a TRP, and/or a base station, such as base station 102) along with an angle of arrival (AoA) measurements. As shown, a UE 106, which may be a target UE, may exchange sidelink reference signals (RSs) (e.g., such as sidelink PRSs and/or sidelink SRSs) with a supporting device 812. As yet another example, FIG. 6D illustrates an RTT scheme in which a relative position of a UE may be determined using a supporting device (e.g., such as an other UE, a RSU, a PSU, a TRP, and/or a base station, such as base station 102) along with an angle of arrival (AoA) measurements. As shown, a UE 106, which may be a target UE, may exchange sidelink reference signals (RSs) (e.g., such as sidelink PRSs and/or sidelink SRSs) with a supporting device 812.

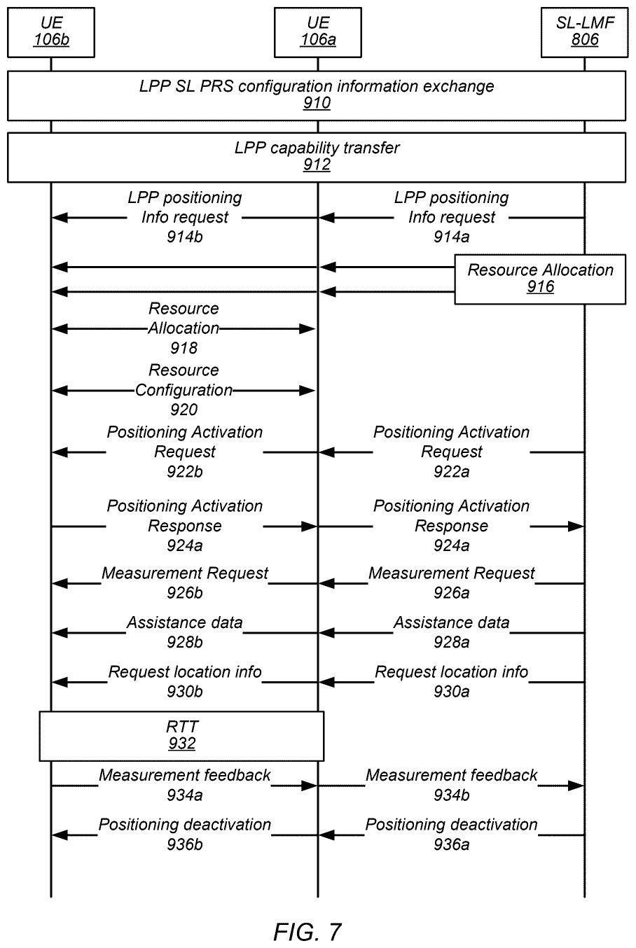

FIG. 7 illustrates an example of signaling for a sidelink procedure for RTT, according to some embodiments. The signaling shown in FIG. 7 may be used in conjunction with any of the systems, methods, or devices shown in the Figures, among other devices. In various embodiments, some of the signaling shown may be performed concurrently, in a different order than shown, or may be omitted. Additional signaling may also be performed as desired. As shown, this signaling may flow as follows.

At 910, a sidelink LMF, such as SL-LMF 806 (which may function similarly to an LMF 609 except outside of the core network) may exchange signaling with one or more UEs (e.g., UEs 106a-106b) to exchange sidelink PRS information, e.g., such as LPP/NRPPa SL PRS configuration information. Note that whether LPP or NRPPa is used may depend on whether the communication is between the LMF and the UEs or between the LMF and a base station. Then at 912, the sidelink LMF may transfer/exchange capabilities (e.g., using the LPP) with the one or more UEs. Further, a first UE, e.g., UE 106a, may receive, from the sidelink LMF, a positioning information request, e.g., such as an LPP positioning information request 914a, and send, to a second UE, e.g., UE 106b, a positioning information request, e.g., such as an LPP positioning information request 914b. At 916, the sidelink LMF may determine a resource allocation, e.g., for a sidelink procedure for RTT. Note that this may be a sidelink Mode 1-type allocation (in which the base station controls the resource allocation) or sidelink Mode 2-type resource allocation (in which the sidelink UEs control the resource allocation). The allocation may be via higher layer configuration or can be dynamic, e.g., via sidelink control information (SCI) and/or a medium access control (MAC) control element (CE). The first UE may receive, from the sidelink LMF, the resource allocation and send, to the second UE, the resource allocation. At 918, the first UE and the second UE may determine a resource allocation and then, at 920, the first UE and the second UE may determine a resource configuration. Then, the first UE may receive, from the sidelink LMF, a request to activate positioning, e.g., positioning activation request 922a, and send, to the second UE, a request to activate positioning, e.g., positioning activation request 922b. The first UE may receive, from the second UE, a response to the positioning activation request, e.g., positioning activation response 924a, and send, to the sidelink LMF, a response to the positioning activation request, e.g., positioning activation response 924b. The first UE may receive, from the sidelink LMF, a measurement request, e.g., measurement request 926a, and send, to the second UE, a measurement request, e.g., measurement request 926b. Additionally, the first UE may receive, from the sidelink LMF, assistance data, e.g., assistance data 928a, and send, to the second UE, assistance data, e.g., assistance data 928b. The assistance data may be provided via on of PC5 LPP and/or PC5 NRPPa. Further, the first UE may receive, from the sidelink LMF, a location information request, e.g., request location information 930a, and send, to the second UE, a location information request, e.g., request location information 930b. Then, based on the resource allocation, resource configuration, and assistance data, the first UE may perform an RTT procedure 932 with the second UE. The RTT procedure may be single sided or double sided. The RTT procedure may also include AoA measurements. After the RTT procedure 932, the first UE may receive, from the second UE, measurement feedback, e.g., measurement feedback 934a, and may send, to the sidelink LMF, the measurement feedback. The measurement feedback may be via one of PC5 LPP and/or PC5 NRPPa. The sidelink LMF may derive the range and/or locations of the first UE and/or second UE. The first UE may receive, from the sidelink LMF, an instruction to deactivate positioning, e.g., positioning deactivation 936a, and send, to the second UE, an instruction to deactivate positioning, e.g., positioning deactivation 936b.

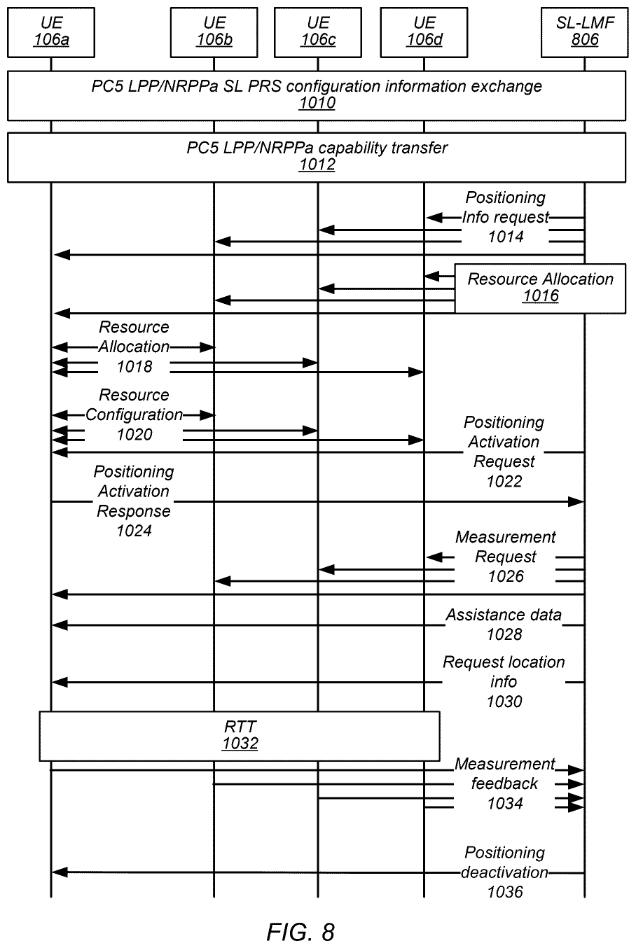

FIG. 8 illustrates an example of signaling for a sidelink procedure for multi-RTT, according to some embodiments. The signaling shown in FIG. 8 may be used in conjunction with any of the systems, methods, or devices shown in the Figures, among other devices. In various embodiments, some of the signaling shown may be performed concurrently, in a different order than shown, or may be omitted. Additional signaling may also be performed as desired. As shown, this signaling may flow as follows.

At 1010, a sidelink LMF, such as SL-LMF 806 (which may function similarly to an LMF 609 except outside of the core network) may exchange signaling with multiple UEs (e.g., UEs 106a-106d) to exchange sidelink PRS information, e.g., such as PC5 LPP/NRPPa SL PRS configuration information. Note that whether LPP or NRPPa is used may depend on whether the UEs are in an LTE cell (e.g., served by an LTE base station) or an NR cell (e.g., served by an NR base station. Then at 1012, the sidelink LMF may transfer/exchange PC5 LLP/NRPPa capabilities with the multiple UEs. Further, the multiple UEs, e.g., UE 106a, as well as supporting UEs 106b-d, may receive, from the sidelink LMF, a positioning information request, e.g., such as an PC5 LLP/NRPPa positioning information request 1014. At 1016, the sidelink LMF may determine a resource allocation, e.g., for a sidelink procedure for RTT. Note that this may be a sidelink Mode 1 or sidelink Mode 2 resource allocation. The allocation may be via higher layer configuration or can be dynamic, e.g., via sidelink control information (SCI) and/or a medium access control (MAC) control element (CE). At 1018, the first UE, e.g., UE 106a, and the supporting UEs, e.g., 106b-d, may determine a resource allocation (e.g., the first UE may determine a resource allocation with each of the supporting UEs) and then, at 1020, the first UE and the supporting UEs may determine a resource configuration (e.g., the first UE may determine a resource configuration with each of the supporting UEs). Then, the first UE may receive, from the sidelink LMF, a request to activate positioning, e.g., positioning activation request 1022, and send, to the sidelink LMF, a response to the positioning activation request, e.g., positioning activation response 1024. The multiples UEs, e.g., the first UE and the supporting UEs, may receive, from the sidelink LMF, a measurement request, e.g., measurement request 1026 and assistance data 1028. The assistance data may be provided via on of PC5 LPP and/or PC5 NRPPa. Further, the multiples UEs, e.g., the first UE and the supporting UEs may receive, from the sidelink LMF, a location information request, e.g., request location information 1030. Then, based on the resource allocation, resource configuration, and assistance data, the first UE may perform an RTT procedure 1032 with each of the supporting UEs. The RTT procedure may be single sided or double sided. The RTT procedure may also include AoA measurements. After the RTT procedure 1032, the multiple UEs may send, to the sidelink LMF, the measurement feedback. The measurement feedback may be via one of PC5 LPP and/or PC5 NRPPa. The sidelink LMF may derive the range and/or locations of the first UE. The first UE may receive, from the sidelink LMF, an instruction to deactivate positioning, e.g., positioning deactivation 1036.

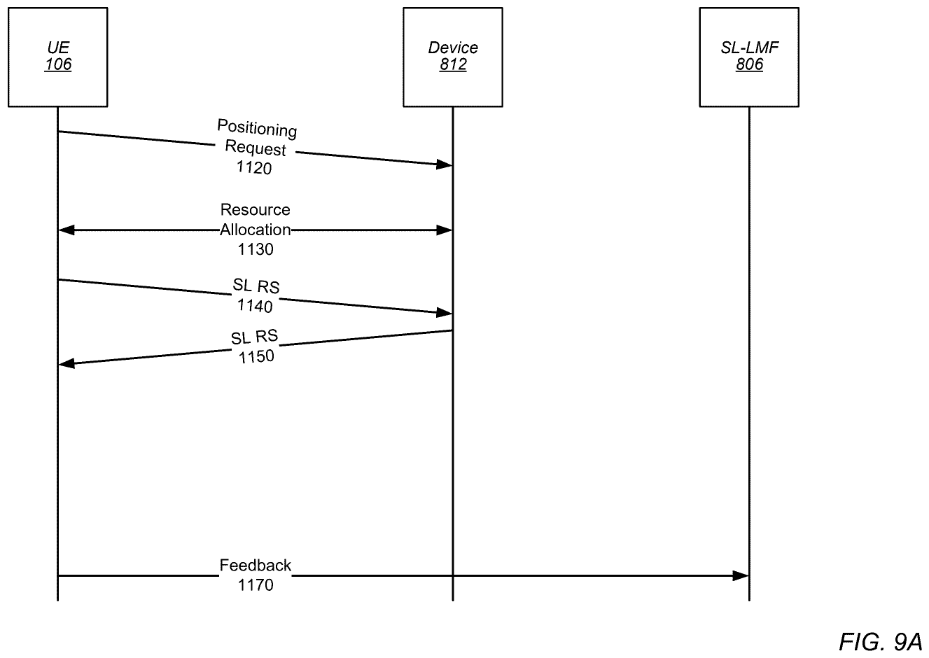

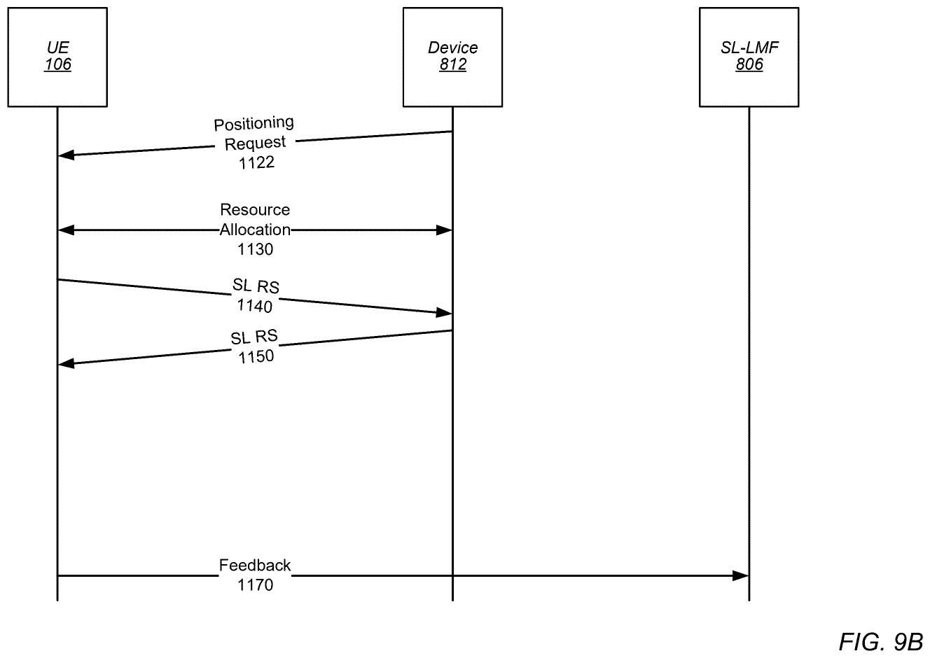

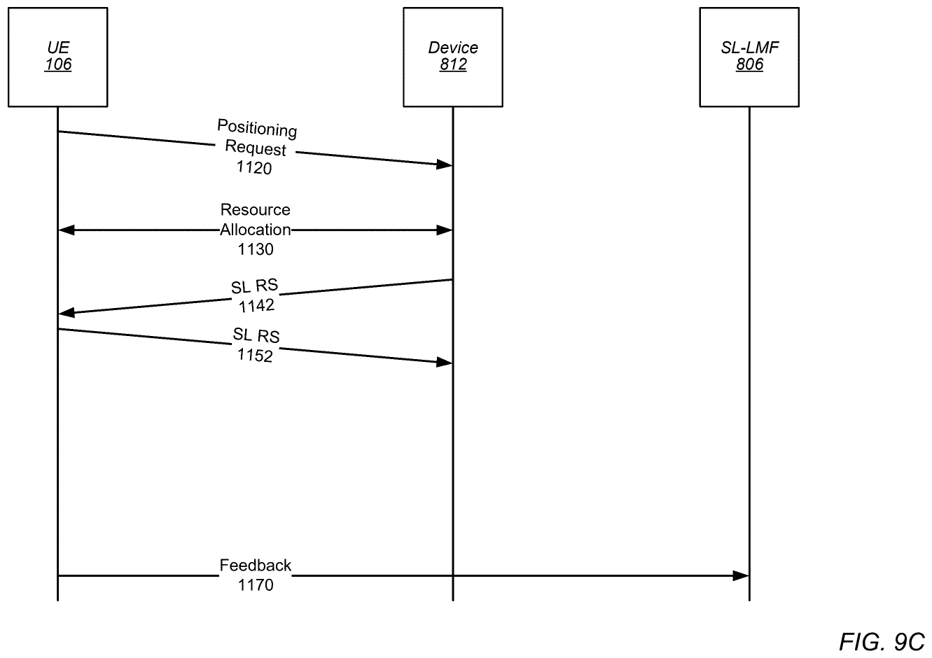

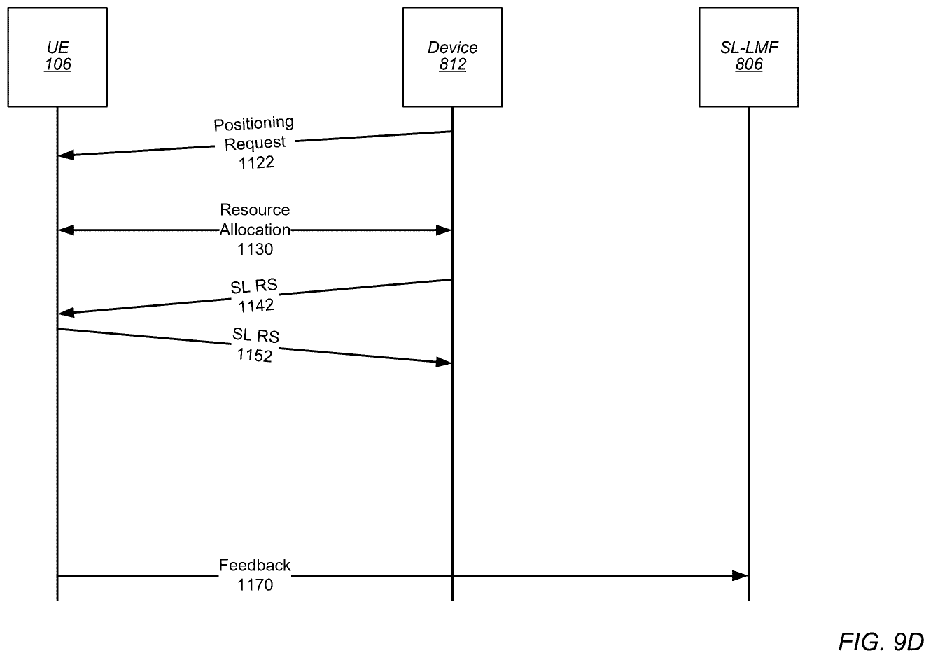

FIGS. 9A-9D illustrate examples of signaling for a sidelink single sided RTT, according to some embodiments. The signaling shown in FIGS. 9A-9D may be used in conjunction with any of the systems, methods, or devices shown in the Figures, among other devices. In various embodiments, some of the signaling shown may be performed concurrently, in a different order than shown, or may be omitted. Additional signaling may also be performed as desired. As shown, this signaling may flow as follows.

FIG. 9A illustrates an example of signaling for a sidelink single sided RTT in which a target UE, e.g., UE 106, is both a requestor and an initiator of the sidelink single sided RTT. As shown, a target device, e.g., UE 106, may send a positioning request 1120 to a supporting device, e.g., supporting device 812. At 1130, the target device and the supporting device may determine a resource allocation for the single sided RTT. Then, the target device, e.g., the initiator, may send a sidelink reference signal 1140, e.g., a sidelink positioning sounding reference single (SRS) and/or a sidelink positioning reference signal (PRS), to the supporting device. The target device may receive, from the supporting device, a sidelink reference signal 1150. After measurement, the target device may send RTT feedback, e.g., feedback 1170, to a sidelink LMF, such as sidelink LMF 806 for position and/or range estimation.

FIG. 9B illustrates an example of signaling for a sidelink single sided RTT in which a target UE, e.g., UE 106, is an initiator of the sidelink single sided RTT and a supporting device, e.g., device 812, which may be a UE and/or another sidelink entity, is a requestor of the sidelink single sided RTT. As shown, a target device, e.g., UE 106, may receive a positioning request 1122 from a supporting device, e.g., supporting device 812. At 1130, the target device and the supporting device may determine a resource allocation for the single sided RTT. Then, the target device, e.g., the initiator, may send a sidelink reference signal 1140, e.g., a sidelink positioning sounding reference single (SRS) and/or a sidelink positioning reference signal (PRS), to the supporting device. The target device may receive, from the supporting device, a sidelink reference signal 1150. After measurement, the target device may send RTT feedback, e.g., feedback 1170, to a sidelink LMF, such as sidelink LMF 806 for position and/or range estimation.

FIG. 9C illustrates an example of signaling for a sidelink single sided RTT in which a target UE, e.g., UE 106, is a requestor of the sidelink single sided RTT and a supporting device, e.g., device 812, which may be a UE and/or another sidelink entity, is an initiator of the sidelink single sided RTT. As shown, a target device, e.g., UE 106, may send a positioning request 1120 to a supporting device, e.g., supporting device 812. At 1130, the target device and the supporting device may determine a resource allocation for the single sided RTT. Then, the target device may receive a sidelink reference signal 1142, e.g., a sidelink positioning sounding reference single (SRS) and/or a sidelink positioning reference signal (PRS), from the supporting device, e.g., the initiator. The target device may send, to the supporting device, a sidelink reference signal 1152. After measurement, the target device may send RTT feedback, e.g., feedback 1170, to a sidelink LMF, such as sidelink LMF 806 for position and/or range estimation.

FIG. 9D illustrates an example of signaling for a sidelink single sided RTT in which a supporting device, e.g., device 812, which may be a UE and/or another sidelink entity, is both a requestor and an initiator of the sidelink single sided RTT. As shown, a target device, e.g., UE 106, may receive a positioning request 1122 from a supporting device, e.g., supporting device 812. At 1130, the target device and the supporting device may determine a resource allocation for the single sided RTT. Then, the target device may receive a sidelink reference signal 1142, e.g., a sidelink positioning sounding reference single (SRS) and/or a sidelink positioning reference signal (PRS), from the supporting device, e.g., the initiator. The target device may send, to the supporting device, a sidelink reference signal 1152. After measurement, the target device may send RTT feedback, e.g., feedback 1170, to a sidelink LMF, such as sidelink LMF 806 for position and/or range estimation.

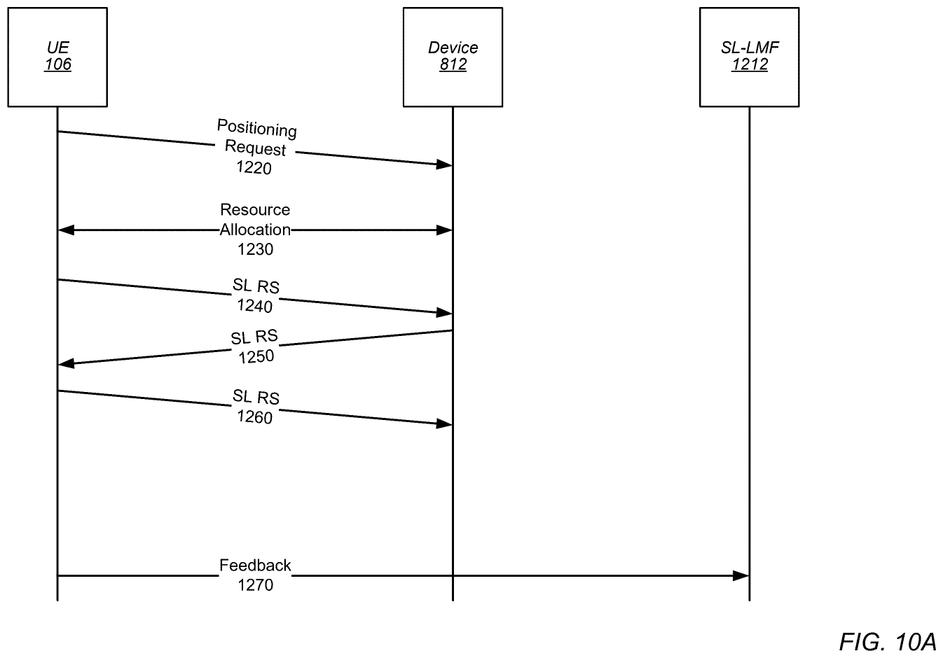

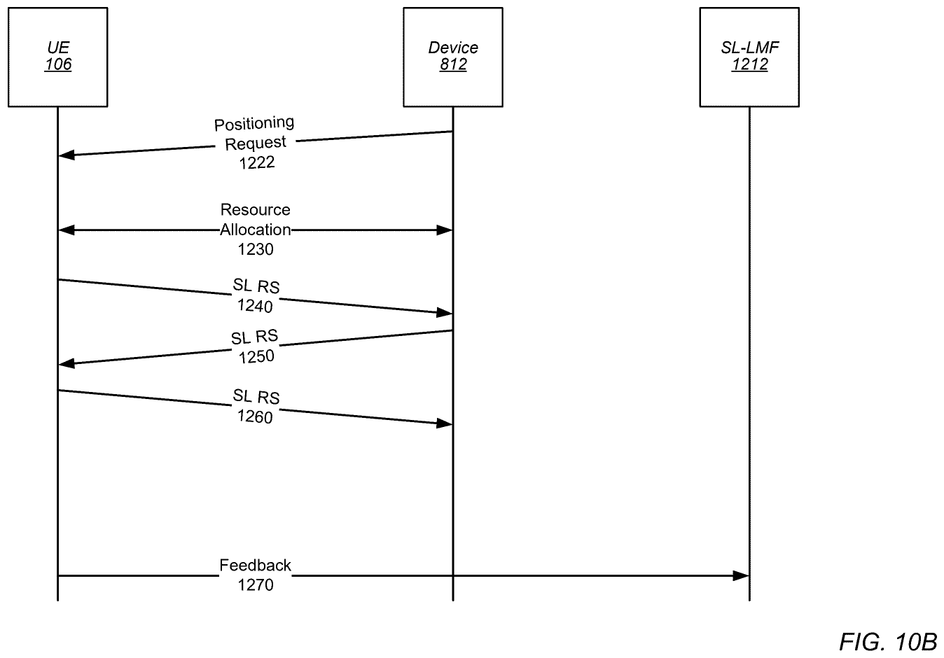

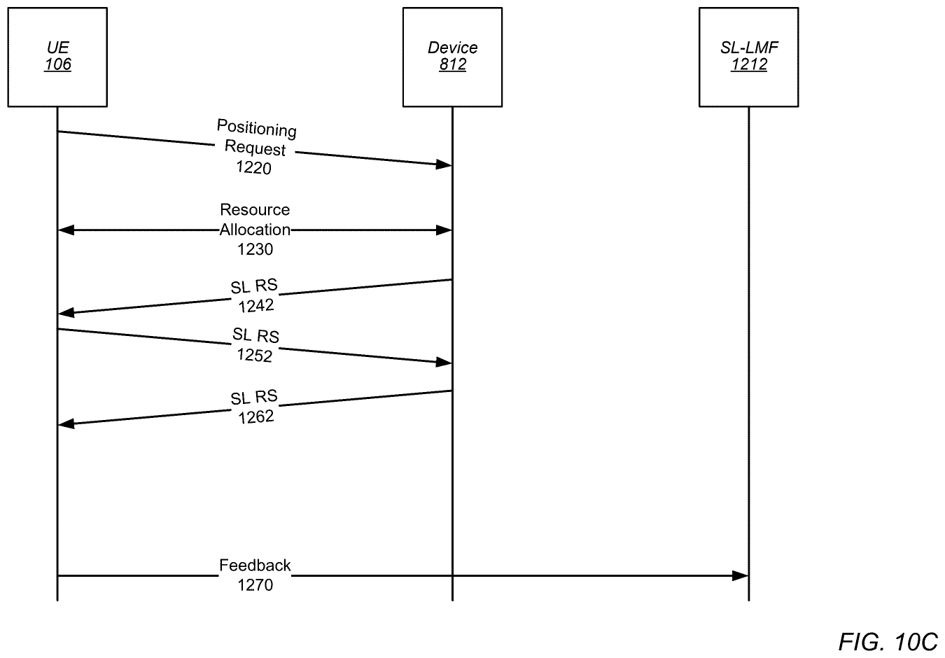

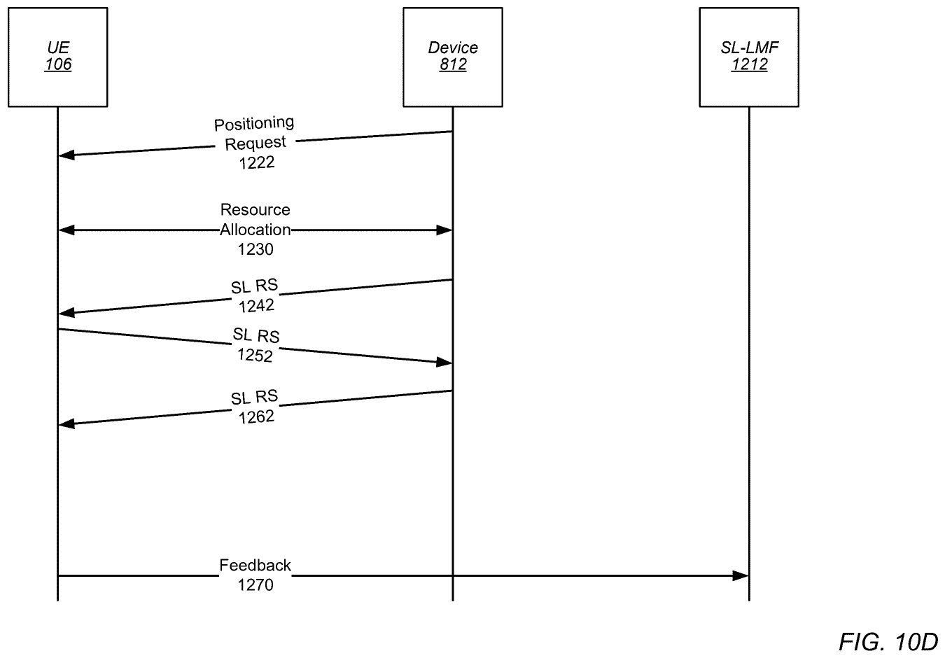

FIGS. 10A-10D illustrate examples of signaling for a sidelink double sided RTT, according to some embodiments. The signaling shown in FIGS. 10A-10D may be used in conjunction with any of the systems, methods, or devices shown in the Figures, among other devices. In various embodiments, some of the signaling shown may be performed concurrently, in a different order than shown, or may be omitted. Additional signaling may also be performed as desired. As shown, this signaling may flow as follows.

FIG. 10A illustrates an example of signaling for a sidelink double sided RTT in which a target UE, e.g., UE 106, is both a requestor and an initiator of the sidelink double sided RTT. As shown, a target device, e.g., UE 106, may send a positioning request 1220 to a supporting device, e.g., supporting device 812. At 1230, the target device and the supporting device may determine a resource allocation for the double sided RTT. Then, the target device, e.g., the initiator, may send a sidelink reference signal 1240, e.g., a sidelink positioning sounding reference single (SRS) and/or a sidelink positioning reference signal (PRS), to the supporting device. The target device may receive, from the supporting device, a sidelink reference signal 1250. The target device may then send, to the supporting device, a sidelink reference signal 1260. After measurement, the target device may send RTT feedback, e.g., feedback 1270, to a sidelink LMF, such as sidelink LMF 806 for position and/or range estimation.

FIG. 10B illustrates an example of signaling for a sidelink double sided RTT in which a target UE, e.g., UE 106, is an initiator of the sidelink double sided RTT and a supporting device, e.g., device 812, which may be a UE and/or another sidelink entity, is a requestor of the sidelink double sided RTT. As shown, a target device, e.g., UE 106, may receive a positioning request 1222 from a supporting device, e.g., supporting device 812. At 1230, the target device and the supporting device may determine a resource allocation for the double sided RTT. Then, the target device, e.g., the initiator, may send a sidelink reference signal 1240, e.g., a sidelink positioning sounding reference single (SRS) and/or a sidelink positioning reference signal (PRS), to the supporting device. The target device may receive, from the supporting device, a sidelink reference signal 1250. The target device may then send, to the supporting device, a sidelink reference signal 1260. After measurement, the target device may send RTT feedback, e.g., feedback 1270, to a sidelink LMF, such as sidelink LMF 806 for position and/or range estimation.

FIG. 10C illustrates an example of signaling for a sidelink double sided RTT in which a target UE, e.g., UE 106, is a requestor of the sidelink double sided RTT and a supporting device, e.g., device 812, which may be a UE and/or another sidelink entity, is an initiator of the sidelink double sided RTT. As shown, a target device, e.g., UE 106, may send a positioning request 1220 to a supporting device, e.g., supporting device 812. At 1230, the target device and the supporting device may determine a resource allocation for the double sided RTT. Then, the target device may receive a sidelink reference signal 1242, e.g., a sidelink positioning sounding reference single (SRS) and/or a sidelink positioning reference signal (PRS), from the supporting device, e.g., the initiator. The target device may send, to the supporting device, a sidelink reference signal 1252. The target device may then receive, from the supporting device, a sidelink reference signal 1262. After measurement, the target device may send RTT feedback, e.g., feedback 1270, to a sidelink LMF, such as sidelink LMF 806 for position and/or range estimation.

FIG. 10D illustrates an example of signaling for a sidelink double sided RTT in which a supporting device, e.g., device 812, which may be a UE and/or another sidelink entity, is both a requestor and an initiator of the sidelink double sided RTT. As shown, a target device, e.g., UE 106, may receive a positioning request 1222 from a supporting device, e.g., supporting device 812. At 1230, the target device and the supporting device may determine a resource allocation for the double sided RTT. Then, the target device may receive a sidelink reference signal 1242, e.g., a sidelink positioning sounding reference single (SRS) and/or a sidelink positioning reference signal (PRS), from the supporting device, e.g., the initiator. The target device may send, to the supporting device, a sidelink reference signal 1252. The target device may then receive, from the supporting device, a sidelink reference signal 1262. After measurement, the target device may send RTT feedback, e.g., feedback 1270, to a sidelink LMF, such as sidelink LMF 806 for position and/or range estimation.

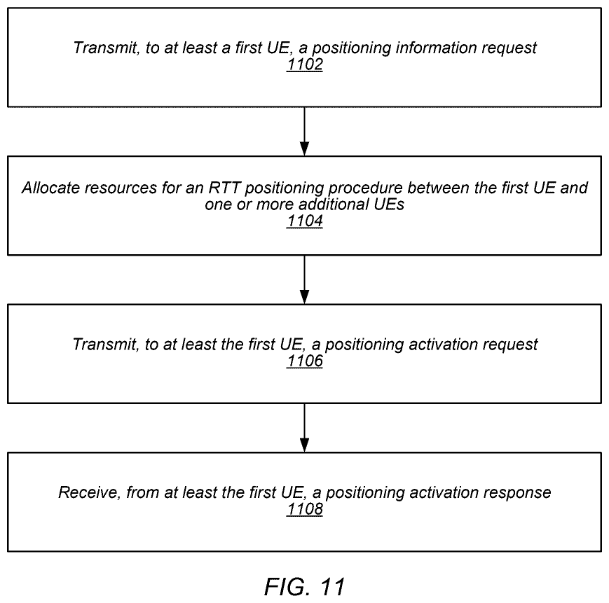

FIG. 11 illustrates a block diagram of an example of a method for round trip time (RTT) based sidelink positioning, according to some embodiments. The method shown in FIG. 11 may be used in conjunction with any of the systems, methods, or devices shown in the Figures, among other devices. In various embodiments, some of the method elements shown may be performed concurrently, in a different order than shown, or may be omitted. Additional method elements may also be performed as desired. As shown, this method may operate as follows.

At 1102, a sidelink LMF, e.g., such as SL LMF 806, may transmit, to at least a first UE, such as UE 106, a positioning information request. The positioning information request may be at least one of a Long Term Evolution (LTE) positioning procedure (LPP) positioning information request or an NR positioning protocol A (NRPPa) positioning information request.

At 1104, resources for an RTT positioning procedure between the first UE and one or more additional UEs, which may be UEs 106 and/or supporting devices 812 may be allocated. The resource allocation may be according to sidelink Mode 1 or sidelink Mode 2. In some instances, the resources may be allocated by a sidelink LMF. In some instances, to allocate resources for the RTT positioning procedure, the sidelink LMF may allocate resources for transmission of sidelink positioning reference signals (PRSs) and/or sidelink sounding reference signals (SRSs).

At 1106, the sidelink LMF may transmit, to at least the first UE, a positioning activation request.

At 1108, the sidelink LMF may receive, from at least the first UE, a positioning activation response.

In some instances, the sidelink LMF may transmit, to at least the first UE, a measurement request and provide, to at least the first UE, assistance data. In addition, the sidelink LMF may request, from at least the first UE, location information and receive, a measurement response. The measurement response may include RTT measurements. In some instances, the measurement response may also include angle of arrival (AoA) and/or angle of departure (AoD) measurements. In some instances, the measurement response may be via PC5 LPP/NRPPa. In some instances, the sidelink LMF may transmit, to at least the first UE, a positioning deactivation instruction, e.g., in response to receiving the measurement response from the at least first UE.

In some instances, e.g., when the RTT positioning procedure comprises a multi-RTT positioning procedure, the sidelink LMF may transmit, to the first UE and two or more additional UEs, a measurement request and provide, to the first UE and two or more additional UEs, assistance data. The sidelink LMF may request, to the first UE and two or more additional UEs, location information and receive, from the first UE and two or more additional UEs, a measurement response. The measurement response may include RTT measurements. In some instances, the measurement response may also include angle of arrival (AoA) and/or angle of departure (AoD) measurements. In some instances, the measurement response may be via PC5 LPP/NRPPa.

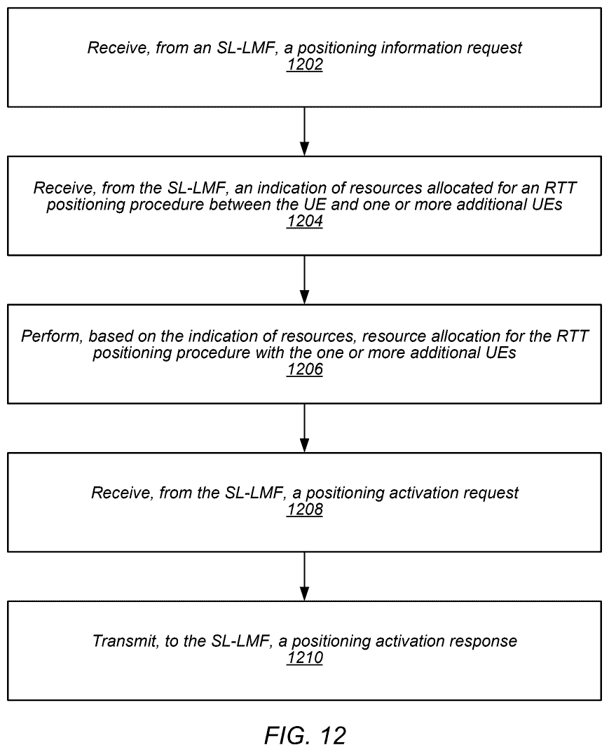

FIG. 12 illustrates a block diagram of another example of a method for round trip time (RTT) based sidelink positioning, according to some embodiments. The method shown in FIG. 12 may be used in conjunction with any of the systems, methods, or devices shown in the Figures, among other devices. In various embodiments, some of the method elements shown may be performed concurrently, in a different order than shown, or may be omitted. Additional method elements may also be performed as desired. As shown, this method may operate as follows.

At 1202, a UE, such as UE 106, may receive, from a sidelink LMF, e.g., such as SL-LMF 806, a positioning information request. The positioning information request may be at least one of a Long Term Evolution (LTE) positioning procedure (LPP) positioning information request or an NR positioning protocol A (NRPPa) positioning information request.

At 1204, the UE may receive an indication of resources allocated for an RTT positioning procedure between the UE and one or more additional UEs. The resource allocation may be according to sidelink Mode 1 or sidelink Mode 2. In some instances, the SL LMF may allocate the resources. In some instances, to allocate resources for the RTT positioning procedure, the sidelink LMF may allocate resources for transmission of sidelink positioning reference signals (PRSs) and/or sidelink sounding reference signals (SRSs).

At 1206, the UE may perform, based on the indication of resources, resource allocation for the RTT positioning procedure with the one or more additional UEs.

At 1208, the UE may receive, from the SL-LMF, a positioning activation request.

At 1210, the UE may transmit, to the SL-LMF, a positioning activation response.

In some instances, the UE may receive, from the SL-LMF, a measurement request, assistance data, and/or location information. The UE may perform the RTT positioning procedure with the one or more additional UEs. The RTT positioning procedure may be a singled sided RTT procedure or a double sided RTT procedure. In some instances, the UE may request performance of the RTT procedure and initiate the RTT procedure. In some instances, the UE may request performance of the RTT procedure by not initiate the RTT procedure. In some instances, the UE may receive a request to perform the RTT procedure and initiate the RTT procedure. In some instances, the UE may receive a request to perform the RTT procedure and wait for the requestor to imitate the RTT procedure. The UE may transmit, to the SL-LMF, a measurement response. The measurement response may include RTT measurements. In some instances, the measurement response may also include angle of arrival (AoA) and/or angle of departure (AoD) measurements. In some instances, the measurement response may be via PC5 LPP/NRPPa. The UE may then receive, from the SL-LMF, a positioning deactivation instruction, e.g., in response to transmitting a measurement response.

In some instances, e.g., when the RTT positioning procedure is a single sided RTT positioning procedure and the UE initiates the RTT positioning procedure, to perform the RTT positioning procedure with the one or more additional UEs, the UE may transmit, to at least one UE of the one or more additional UEs, a first positioning reference signal (PRS) and receive, from the at least one UE, a second PRS.

In some instances, e.g., when the RTT positioning procedure is a single sided RTT positioning procedure and the UE is not the initiator of the RTT positioning procedure, to perform the RTT positioning procedure with the one or more additional UEs, the UE may receive, from at least one UE of the one or more additional UEs, a first positioning reference signal (PRS) and transmit, to the at least one UE, a second PRS

In some instances, e.g., when the RTT positioning procedure is a double sided RTT positioning procedure and the UE initiates the RTT positioning procedure, to perform the RTT positioning procedure with the one or more additional UEs, the UE may transmit, to at least one UE of the one or more additional UEs, a first positioning reference signal (PRS) and receive, from the at least one UE, a second PRS. Further, the UE may transmit, to the at least one UE, a third PRS.

In some instances, e.g., when the RTT positioning procedure is a double sided RTT positioning procedure and the UE is not the initiator of the RTT positioning procedure, to perform the RTT positioning procedure with the one or more additional UEs, the UE may receive, from at least one UE of the one or more additional UEs, a first positioning reference signal (PRS) and transmit, to the at least one UE, a second PRS. Further, the UE may receive, from the at least one UE, a third PRS.

In some instances, e.g., when the RTT positioning procedure comprises a multi-RTT single sided positioning procedure, and the UE initiates the multi-RTT positioning procedure, to perform the RTT positioning procedure with the one or more additional UEs, the UE may transmit, to at least two UEs of the one or more additional UEs, positioning reference signals (PRS) and receive, from the at least two UEs, PRSs.

In some instances, e.g., when the RTT positioning procedure comprises a multi-RTT double sided positioning procedure, and the UE initiates the multi-RTT positioning procedure, to perform the RTT positioning procedure with the one or more additional UEs, the UE may transmit, to at least two UEs of the one or more additional UEs, positioning reference signals (PRS) and receive, from the at least two UEs, PRSs. Additionally, the UE may transmit, to the at least two UEs, PRSs.

### Passive Sidelink Ranging

In some instances, a passive sidelink ranging procedure may include RTT sidelink RS (e.g., PRS and/or SRS) transmissions between various supporting devices, e.g., other UEs, RSUs, and/or PSUs. A passive UE (e.g., a UE that does not transmit in the RTTs but is the target of the passive sidelink ranging procedure) may use the RTT sidelink RS transmissions and associated feedback to estimate a differential distance to each supporting device. Such a scheme may reduce positioning transmission overhead while enhancing privacy of the target UE and reducing power consumption at the target UE. The transmissions between the supporting devices may be transmitted in a dedicated positioning slot with a passive sidelink (SL) sidelink control information (SCI) that may indicate a configuration and timing of the transmitted sidelink RSs for passive sidelink positioning. In some instances, the SCI may include a schedule and/or configuration of the sidelink RS transmissions for RTTs between a primary supporting device and one or more secondary supporting devices. In addition, the SCI may include a feedback configuration for the one or more secondary devices. For example, in some instances, the feedback may be directed to the primary device. As another example, in some instances, the feedback may be broadcast to all devices. Additionally, in some instances, the SCI may include a schedule of broadcast information for passive devices.

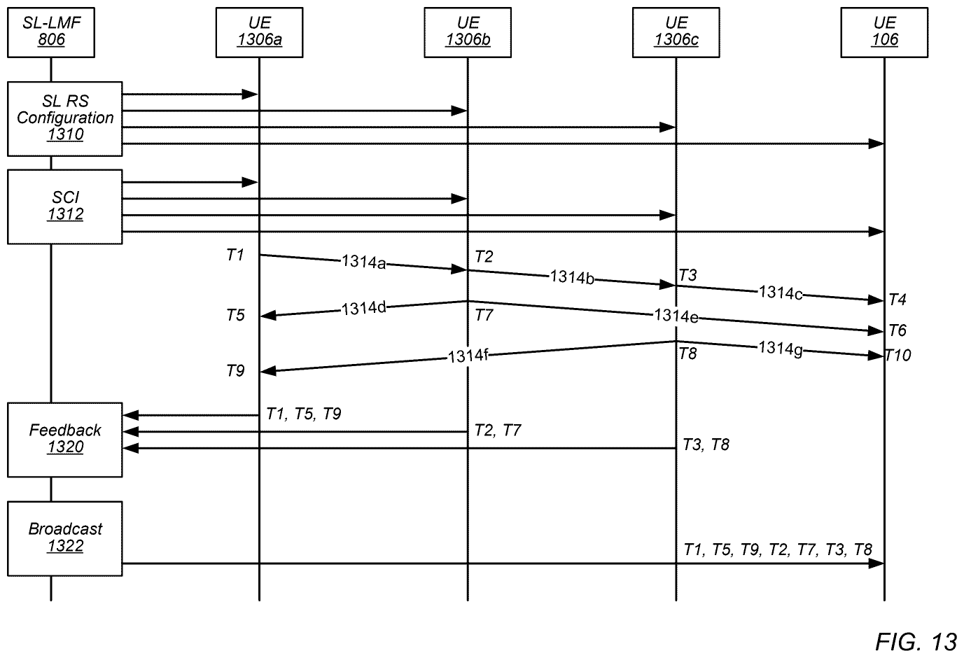

FIG. 13 illustrates an example of signaling for a passive sidelink ranging procedure with RTT, according to some embodiments. The signaling shown in FIG. 13 may be used in conjunction with any of the systems, methods, or devices shown in the Figures, among other devices. In various embodiments, some of the signaling shown may be performed concurrently, in a different order than shown, or may be omitted. Additional signaling may also be performed as desired. As shown, this signaling may flow as follows.

At 1310, a sidelink LMF, such as SL-LMF 806, may send a sidelink reference signal configuration to a target UE, e.g., such as UE 106, and one or more supporting devices, such as UEs 1306a-c. Note that the one or more supporting devices may be UEs as designated, may be other sidelink devices, such as road side units (RSUs) and/or positioning sidelink units (PSUs), and/or a combination thereof. The sidelink reference signal configuration may include a sidelink positioning reference signal (PRS) configuration and/or a sidelink sounding reference signal (SRS) configuration for positioning. In addition, at 1312, the sidelink LMF may send to the target UE and the one or more supporting UEs. sidelink control information (SCI). The SCI may include a schedule of PRS/SRS transmissions, a configuration for the PRS/SRS transmission, a feedback configuration for the one or more supporting UEs, and/or a schedule of broadcast information for the target UE. In some instances, the feedback configuration for the one or more supporting UEs may indicate that feedback is directed to the target UE or that the feedback is to be broadcast. In some instances, the PRS/SRS configuration may indicate a standalone PRS/SRS slot configuration, a non-standalone PRS/SRS slot configuration, and/or an indication that the PRS/SRS configuration is periodic or semi-persistent. In some instances, the non-standalone PRS/SRS slot configuration may indicate that the PRS/SRS is multiplexed with a physical sidelink shared channel (PSSCH).

Upon receipt of the sidelink PRS/SRS configuration and the SCI, the supporting UEs may perform RTT transmissions with one another and the target UE. Thus, a first UE of the supporting UEs, e.g., UE 1306a, may send, at time T1, a PRS/SRS transmission 1314a to a second UE of the supporting UEs, e.g., UE 1306b. The second UE may send a PRS/SRS transmission 1314b to a third UE of the supporting UEs, e.g., UE 1306c, at time T2. The third UE may transmit a PRS/SRS transmission 1314c to the target UE at time T3. The target UE may receive the PRS/SRS transmission 1314c at time T4. In addition, the second UE may send a PRS/SRS transmission 1314d to the first UE and a PRS/SRS transmission 1314e to the target UE at time T7. The first UE may receive the PRS/SRS transmission 1314d at Time T5 and the target UE may receive the PRS/SRS transmission 1314e at time T6. The third UE may send a PRS/SRS transmission 1314f to the first UE and a PRS/SRS transmission 1314g to the target UE at time T8. The first UE may receive the PRS/SRS transmission 1314f at time T9 and the target UE may receive the PRS/SRS transmission 1314g at time T10.

At 1320, upon completion of the PRS/SRS transmissions, the supporting UEs may provide feedback to the sidelink LMF. Thus, the first UE may provide times T1, T5, and T9, the second device may provide times T2 and T7, and the third device may provide times T3 and T8. At 1322, the sidelink LMF may then broadcast the times T1, T2, T3, T5, T7, T8 and T9 to the target UE. The target UE may then use these times along with times T4, T6, and T10 to estimate its position relative to the supporting UEs, e.g., without performing any transmissions associated with the positioning procedure. In some instance, the feedback may also include angle of arrival (AoA) and/or angle of departure (AoD) information. In such instances, the sidelink LMF may also broadcast the AoA/AoD information and the target UE may derive its absolute position using the AoA/AoD information in addition to the timing information.

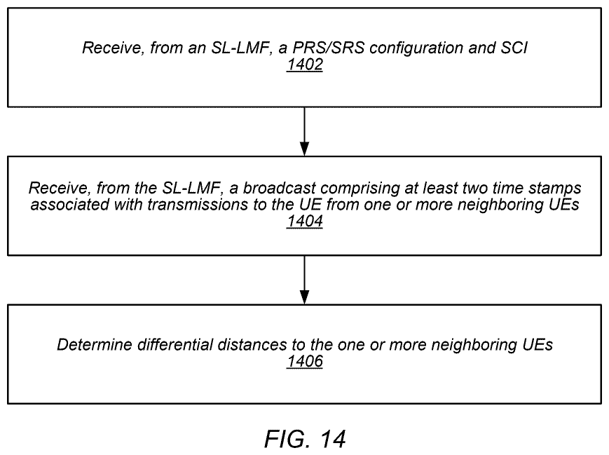

FIG. 14 illustrates a block diagram of an example of a method for passive sidelink positioning estimation, according to some embodiments. The method shown in FIG. 14 may be used in conjunction with any of the systems, methods, or devices shown in the Figures, among other devices. In various embodiments, some of the method elements shown may be performed concurrently, in a different order than shown, or may be omitted. Additional method elements may also be performed as desired. As shown, this method may operate as follows.

At 1402, a UE, such as UE 106, may receive, from a sidelink location management function (LMF), such as SL-LMF 806, a positioning reference signal (PRS)/sounding reference signal (SRS) configuration and sidelink control information (SCI). In some instances, the SCI may include a schedule of PRS/SRS transmissions, a configuration for the PRS/SRS transmission, a feedback configuration for the one or more neighboring UEs, and/or a schedule of broadcast information for the UE. In some instances, the feedback configuration for the one or more neighboring UEs may indicate that feedback is directed to the UE or feedback is to be broadcast. In some instances, the PRS/SRS configuration may indicate a standalone PRS/SRS slot configuration, a non-standalone PRS/SRS slot configuration, and/or an indication that the PRS/SRS configuration is periodic or semi-persistent. In some instances, the non-standalone PRS/SRS slot configuration may indicate that the PRS/SRS is multiplexed with a physical sidelink shared channel (PSSCH).

At 1404, the UE may receive, from the SL-LMF, a broadcast comprising at least two time stamps associated with transmissions to the UE from one or more neighboring UEs. Note that the one or more neighboring UEs may be UEs as designated, may be other sidelink devices, such as road side units (RSUs) and/or positioning sidelink units (PSUs), and/or a combination thereof.

At 1406, the UE may determine differential distances to the one or more neighboring UEs. In some instances, the broadcast from the SL-LMF may include angle of arrival (AoA) information and/or angle of departure (AoD) information. In some instances, the UE may determine an absolute position based on the differential distances and the AoA/AoD information.

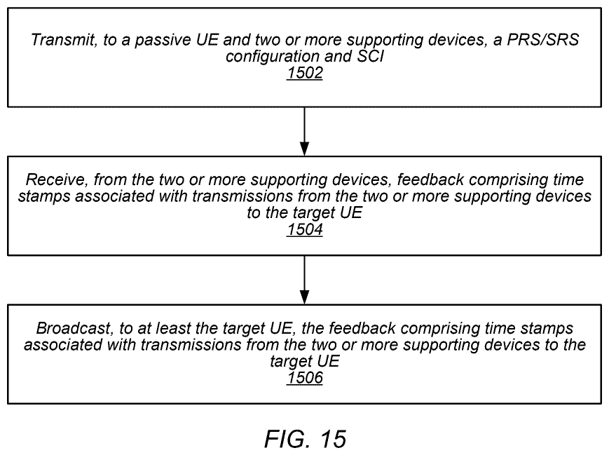

FIG. 15 illustrates a block diagram of an example of a method for passive sidelink positioning estimation, according to some embodiments. The method shown in FIG. 15 may be used in conjunction with any of the systems, methods, or devices shown in the Figures, among other devices. In various embodiments, some of the method elements shown may be performed concurrently, in a different order than shown, or may be omitted. Additional method elements may also be performed as desired. As shown, this method may operate as follows.

At 1502, a sidelink LMF, such as SL-LMF 806, may transmit, to a target UE, such as UE 106, and at least two supporting devices, e.g., UEs, other sidelink devices, such as road side units (RSUs) and/or positioning sidelink units (PSUs), and/or a combination thereof, a positioning reference signal (PRS)/sounding reference signal (SRS) configuration and sidelink control information (SCI). In some instances, the SCI may include a schedule of PRS/SRS transmissions, a configuration for the PRS/SRS transmission, a feedback configuration for the one or more neighboring UEs, and/or a schedule of broadcast information for the UE. In some instances, the feedback configuration for the one or more neighboring UEs may indicate that feedback is directed to the UE or feedback is to be broadcast. In some instances, the PRS/SRS configuration may indicate a standalone PRS/SRS slot configuration, a non-standalone PRS/SRS slot configuration, and/or an indication that the PRS/SRS configuration is periodic or semi-persistent. In some instances, the non-standalone PRS/SRS slot configuration may indicate that the PRS/SRS is multiplexed with a physical sidelink shared channel (PSSCH).

At 1504, the sidelink LMF may receive, from the two or more supporting devices, feedback comprising time stamps associated with transmissions from the two or more supporting devices to the target UE. In some instances, the feedback may include angle of arrival (AoA) and/or angle of departure (AoD) information.

At 1506, the sidelink LMF may broadcast, to at least the target UE, the feedback comprising time stamps associated with transmissions from the two or more supporting devices to the target UE. In some instances, the broadcasted feedback may include AoA and/or AoD information.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

Embodiments of the present disclosure may be realized in any of various forms. For example, some embodiments may be realized as a computer-implemented method, a computer-readable memory medium, or a computer system. Other embodiments may be realized using one or more custom-designed hardware devices such as ASICs. Still other embodiments may be realized using one or more programmable hardware elements such as FPGAs.

In some embodiments, a non-transitory computer-readable memory medium may be configured so that it stores program instructions and/or data, where the program instructions, if executed by a computer system, cause the computer system to perform a method, e.g., any of the method embodiments described herein, or, any combination of the method embodiments described herein, or, any subset of any of the method embodiments described herein, or, any combination of such subsets.

In some embodiments, a device (e.g., a UE 106) may be configured to include a processor (or a set of processors) and a memory medium, where the memory medium stores program instructions, where the processor is configured to read and execute the program instructions from the memory medium, where the program instructions are executable to implement any of the various method embodiments described herein (or, any combination of the method embodiments described herein, or, any subset of any of the method embodiments described herein, or, any combination of such subsets). The device may be realized in any of various forms.

Any of the methods described herein for operating a user equipment (UE) may be the basis of a corresponding method for operating a base station, by interpreting each message/signal X received by the UE in the downlink as message/signal X transmitted by the base station, and each message/signal Y transmitted in the uplink by the UE as a message/signal Y received by the base station.

Although the embodiments above have been described in considerable detail, numerous variations and modifications will become apparent to those skilled in the art once the above disclosure is fully appreciated. It is intended that the following claims be interpreted to embrace all such variations and modifications.

1. A method for passive sidelink positioning estimation, comprising:
a user equipment device (UE),
receiving, from a sidelink location management function (SL-LMF), a positioning reference signal (PRS) configuration and sidelink control information (SCI);
receiving, from the SL-LMF, a broadcast comprising at least two time stamps associated with transmissions to the UE from one or more neighboring UEs; and
determining differential distances to the one or more neighboring UEs.

2. The method of claim 1,
wherein the SCI includes one or more of:
a schedule of PRS transmissions;
a configuration for the PRS transmission;
feedback configuration for the one or more neighboring UEs; or
schedule of broadcast information for the UE.

3. The method of claim 2,
wherein the feedback configuration for the one or more neighboring UEs indicates that feedback is directed to the UE.

4. The method of claim 2,
wherein the feedback configuration for the one or more neighboring UEs indicates that feedback is broadcast.

5. The method of claim 1,
wherein the PRS configuration indicates at least one of:
a standalone PRS slot configuration;
a non-standalone PRS slot configuration;
an indication that the PRS configuration is periodic or semi-persistent.

6. The method of claim 5,
wherein the non-standalone PRS slot configuration indicates that the PRS is multiplexed with a physical sidelink shared channel (PSSCH).

7. The method of claim 1,
wherein the broadcast from the SL-LMF further comprises angle of arrival information.

8. The method of claim 7, further comprising:
the UE,
determining absolute position based on the differential distances and angle of arrival information.

9-11. (canceled)

12. A method for passive sidelink positioning estimation, comprising:
a sidelink location management function (SL-LMF),
transmitting, to a passive user equipment device (UE) and two or more additional UEs, a positioning reference signal (PRS) configuration and sidelink control information (SCI);
receiving, from the two or more additional UEs, feedback comprising time stamps associated with transmissions from the two or more UEs to the passive UE; and
broadcasting, to at least the passive UE, the feedback comprising time stamps associated with transmissions from the two or more UEs to the passive UE.

13. The method of claim 12,
wherein the SCI includes one or more of:
a schedule of PRS transmissions;
a configuration for the PRS transmission;
feedback configuration for the two or more UEs; or
schedule of broadcast information for the passive UE.

14. The method of claim 13,
wherein the feedback configuration for the two or more UEs indicates that feedback is directed to the passive UE or feedback is broadcast.

15. The method of claim 12,
wherein the PRS configuration indicates at least one of:
a standalone PRS slot configuration;
a non-standalone PRS slot configuration;
an indication that the PRS configuration is periodic or semi-persistent.

16. The method of claim 15,
wherein the non-standalone PRS slot configuration indicates that the PRS is multiplexed with a physical sidelink shared channel (PSSCH).

17. The method of claim 12,
wherein the feedback allows the passive UE to determine differential distances to the two or more UEs.

18. The method of claim 12,
wherein the feedback further comprises angle of arrival information.

19. the method of claim 18,
wherein the feedback allows the passive UE to determine an absolute position.

20-22. (canceled)

23. An apparatus, comprising:
a memory; and
at least one processor in communication with the memory and configured to cause a user equipment device (UE) to:
receive, from a sidelink location management function (SL-LMF), a positioning reference signal (PRS) configuration and sidelink control information (SCI);
receive, from the SL-LMF, a broadcast comprising at least two time stamps associated with transmissions to the UE from one or more neighboring UEs; and
determine differential distances to the one or more neighboring UEs.

24. The apparatus of claim 23,
wherein the SCI includes one or more of:
a schedule of PRS transmissions;
a configuration for the PRS transmission;
feedback configuration for the one or more neighboring UEs; or
schedule of broadcast information for the UE.

25. The apparatus of claim 24,
wherein the feedback configuration for the one or more neighboring UEs indicates that feedback is directed to the UE.

26. The apparatus of claim 24,
wherein the feedback configuration for the one or more neighboring UEs indicates that feedback is broadcast.
